(19) United States
(12) Patent Application Publication
(10) Pub. No.: US 2015/0204964 A1
(43) Pub. Date: Jul. 23, 2015

(54) RADIO BASE STATION AND COMPUTER READABLE STORAGE MEDIUM

(71) Applicant: KABUSHIKI KAISHA TOSHIBA, Tokyo (JP)

(72) Inventors: Tatsuma HIRANO, Tokyo (JP); Cam Ly NGUYEN, Tokyo (JP); Hiroyuki KITAGAWA, Tokyo (JP); Ren SAKATA, Tokyo (JP); Takuya KAWAMURA, Tokyo (JP); Mutsumu SERIZAWA, Tokyo (JP)

(21) Appl. No.: 14/598,787

(22) Filed: Jan. 16, 2015

(30) Foreign Application Priority Data
Jan. 20, 2014 (JP) 2014-007960

(51) Int. Cl. G01S 5/06

(52) U.S. Cl. CPC G01S 5/06

(57) ABSTRACT

A radio base station performs wireless communication with a wireless terminal. The radio base station includes a directivity pattern specifying unit, a communication unit, and a signal processor. The directivity pattern specifying unit specifies plural directivity patterns. The communication unit receives a search request frame from the wireless terminal, sends to the wireless terminal a search response frame which is a response to the search request frame, with at least one, specified by the directivity pattern specifying unit, of the directivity patterns, and receives a delivery acknowledgment frame for the search response frame from the wireless terminal with the directivity patterns specified by the directivity pattern specifying unit. The signal processor calculates, for each specified directivity pattern, a radio wave intensity of the delivery acknowledgment frame.

### CROSS-REFERENCE TO RELATED APPLICATION(S)

The present disclosure claims priority to Japanese Patent Application No. 2014-7960, filed on Jan. 20, 2014, which is incorporated herein by reference in its entirety.

### FIELD

Embodiments described herein relate generally to a radio base station and a computer readable storage medium.

### RELATED ART

In communication systems having plural radio base stations which are installed at different locations that are recognized in advance, the position of one wireless terminal can be estimated based on radio wave intensities that are obtained when radio signals emitted from the wireless terminal are received by the plural radio base stations. For example, in wireless communication according to IEEE 802.11, a radio base station can acquire a radio wave intensity of a wireless terminal by (i) sending, to the wireless terminal, a data frame that requests sending-back of an acknowledgment and (ii) receiving an ACK frame as a delivery acknowledgment response from the wireless terminal.

On the other hand, according to a related art, (i) functions are added to wireless terminals and radio base stations that are compatible with IEEE 802.11, (ii) one wireless terminal sends out radio signals having plural directivity patterns, and (iii) one radio base station receives those radio signals and calculates radio wave intensities of the received radio signals having the respective directivity patterns. Enabling acquisition of plural radio wave intensities, this technique allows even a single radio base station to estimate a position of a wireless terminal.

However, since the related art requires a wireless terminal to send radio signals having plural directivity patterns, it is necessary that the wireless terminal and a radio base station be provided with new functions.

### BRIEF DESCRIPTION OF THE DRAWINGS

FIG. 1 is a block diagram showing a communication system according to a first embodiment;

FIG. 2 is a block diagram of a radio base station 110 according to the first embodiment;

FIG. 3 is a sequence diagram showing how the communication system according to the first embodiment operates;

FIG. 4 is a block diagram of a radio base station 110A according to a modification of the first embodiment;

FIG. 5 is a block diagram of a radio base station 210 according to a second embodiment;

FIG. 6 is a sequence diagram showing how a communication system according to the second embodiment operates;

FIG. 7 is a block diagram of a radio base station 310 according to a third embodiment;

FIG. 8 is a correspondence table between MAC addresses and directivity patterns in the radio base station 310 according to the third embodiment;

FIG. 9 is a sequence diagram showing how a communication system according to the third embodiment operates;

FIG. 10 is a block diagram of a radio base station 410 according to a fourth embodiment;

FIG. 11 is a correspondence table between frame types and directivity patterns in the radio base station 410 according to the fourth embodiment;

FIG. 12 is a sequence diagram showing how a communication system according to the fourth embodiment operates;

FIG. 13 is a block diagram of a radio base station 410A according to a modification of the fourth embodiment;

FIG. 14 is a correspondence table between frame types and directivity patterns in the radio base station 410A according to the modification of the fourth embodiment;

FIG. 15 is a sequence diagram showing how a communication system according to the modification of the fourth embodiment operates;

FIG. 16 is a block diagram of a radio base station 510 according to a fifth embodiment;

FIG. 17 is a sequence diagram showing how a communication system according to the fifth embodiment operates;

FIG. 18 is a correspondence table between frame types and directivity patterns in the radio base station 510 according to the fifth embodiment;

FIG. 19 is a block diagram of a radio base station 610 according to a sixth embodiment

FIG. 20 is a sequence diagram showing how a communication system according to the sixth embodiment operates; and

FIG. 21 is a correspondence table between antennas and weight matrices.

### DETAILED DESCRIPTION

Embodiments will be hereinafter described with reference to the accompanying drawings. The same items will be given the same reference symbol in the drawings, and redundant description thereon will be omitted.

According to one embodiment, a radio base station performs wireless communication with a wireless terminal. The radio base station includes a directivity pattern specifying unit, a communication unit, and a signal processor. The directivity pattern specifying unit specifies plural directivity patterns. The communication unit receives a search request frame from the wireless terminal, sends to the wireless terminal a search response frame which is a response to the search request frame, with at least one, specified by the directivity pattern specifying unit, of the directivity patterns, and receives a delivery acknowledgment frame for the search response frame from the wireless terminal with the directivity patterns specified by the directivity pattern specifying unit. The signal processor calculates, for each specified directivity pattern, a radio wave intensity of the delivery acknowledgment frame.

### First Embodiment

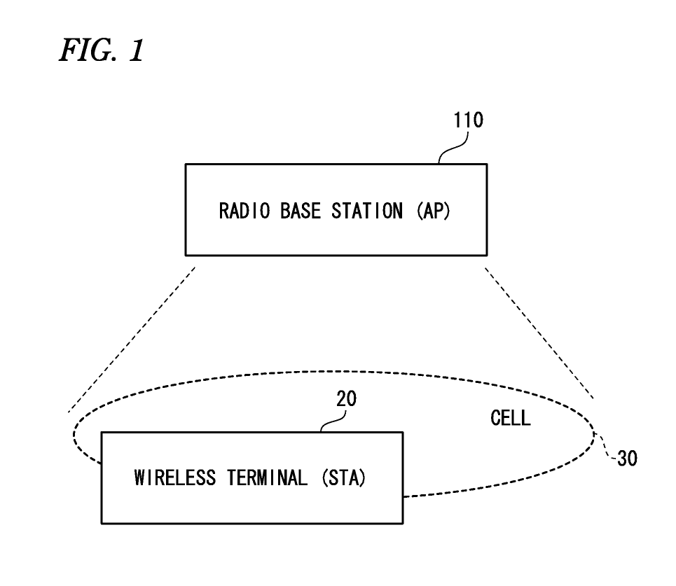

FIG. 1 is a block diagram showing a communication system according to a first embodiment.

The communication system is an infrastructure mode network including a radio base station 110 that performs wireless communication according to IEEE 802.11 and a wireless terminal 20 that exists within a range (cell 30) of the radio base station 110. For example, signal exchange methods of wireless communication according to IEEE 802.11 include one that is performed when the wireless terminal 20 searches for a nearby radio base station at the time of an active scan. To search for a nearby radio base station, the wireless terminal 20 sends out a Probe Request frame (search request frame). Upon receipt of the Probe Request frame, the radio base station 110 sends, to the wireless terminal 20, a Probe Response frame (search response frame) as a response to the Probe Request frame. Upon receipt of the Probe Response frame which is directed to the wireless terminal 20, the wireless terminal 20 sends to the radio base station 110 an ACK (Acknowledgment) frame as a delivery acknowledgment response to the Probe Request frame. With this signal exchange, the wireless terminal 20 can recognize that the radio base station 110 exists near the wireless terminal 20. In the first embodiment, while the wireless terminal 20 performs this signal exchange to search for a radio base station, the radio base station 110 acquires, for each of plural directivity patterns, a radio wave intensity of a radio signal sent from the wireless terminal 20.

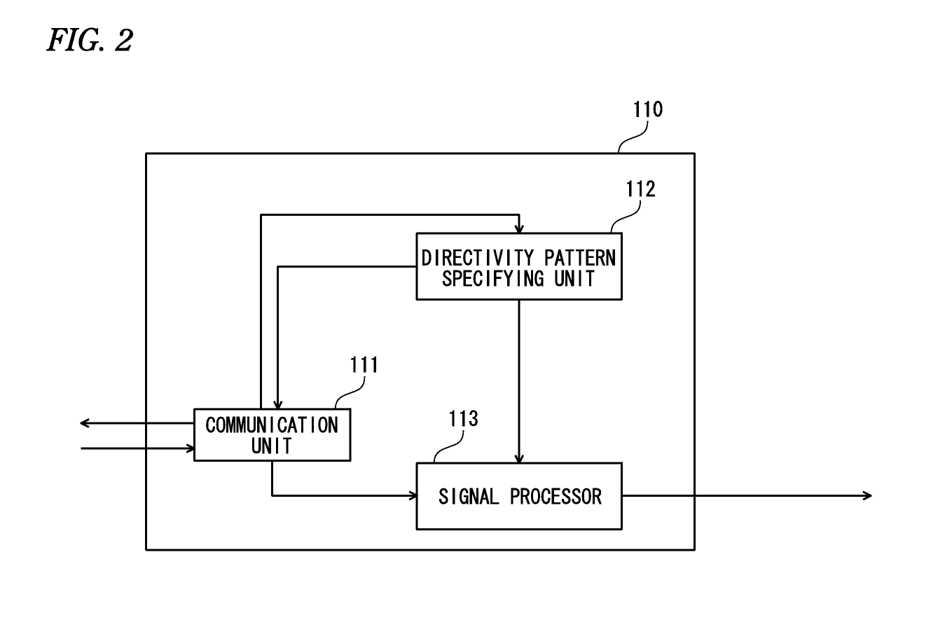

FIG. 2 is a block diagram of the radio base station 110 according to the first embodiment. The radio base station 110 includes a communication unit 111, a directivity pattern specifying unit 112, and a signal processor 113.

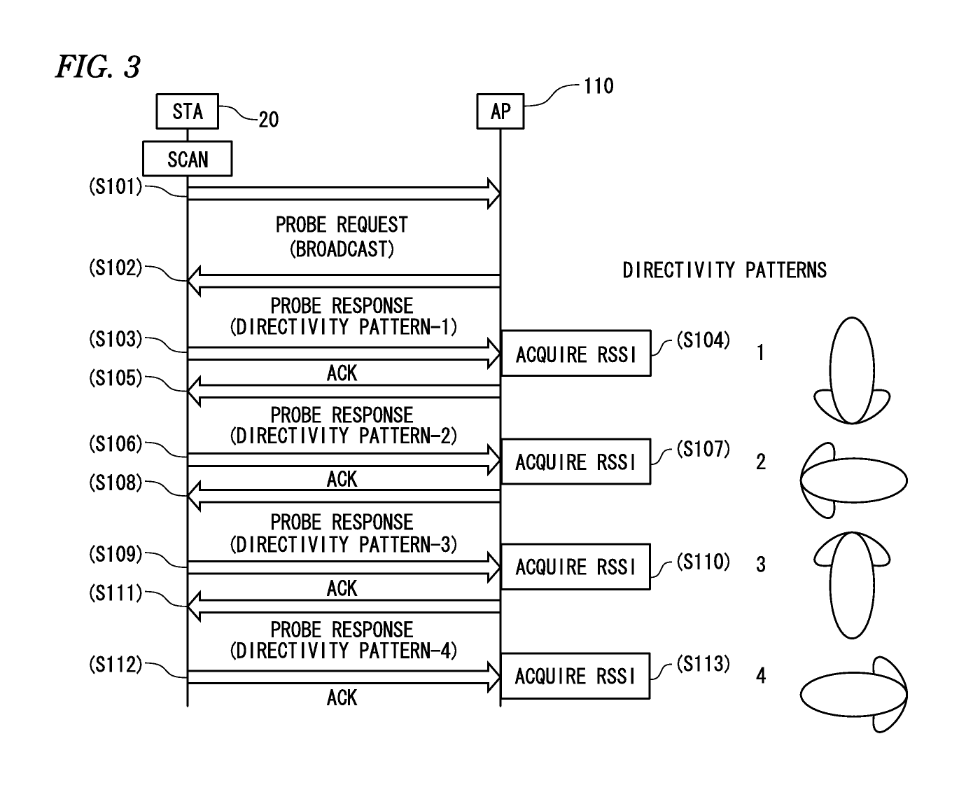

The directivity pattern specifying unit 112 indicates (specifies) to the communication unit 111 plural directivity patterns and causes the communication unit 111 to perform communications using the plural directivity patterns. In the first embodiment, the directivity pattern specifying unit 112 indicates (specifies) four directivity patterns, for example, a directivity pattern-1 to a directivity pattern-4 shown in FIG. 3.

The communication unit 111 communicates with the wireless terminal 20. The communication unit 111 receives, from the wireless terminal 20, a Probe Request frame which includes a MAC address of the wireless terminal 20 in a transmission source address field. The communication unit 111 transmits and receives frames with the directivity patterns specified by the directivity pattern specifying unit 112. The communication unit 111 can realize plural directivity patterns by several methods. For example, where the communication unit 111 includes plural directional antennas, the communication unit 111 can realize plural directivity patterns by switching between the directional antennas. Alternatively, the communication unit 111 can realize different directivity patterns through beam forming using an adaptive array antenna. Further alternatively, the communication unit 111 can realize plural directivity patterns with a non-directional antenna by multiplying transmission signals and reception signals by weight matrices. It should be noted that a way of realizing plural directivity patterns is not limited thereto.

The communication unit 111 sends a Probe Response frame (which is a response to the Probe Request frame) to the wireless terminal 20 with the directivity patterns specified by the directivity pattern specifying unit 112. The communication unit 111 receives an ACK frame for the Probe Response frame from the wireless terminal 20 with the directivity patterns specified by the directivity pattern specifying unit 112. In the first embodiment, the communication unit 111 sends the Probe Response frame with the four patterns, that is, the directivity pattern-1 to directivity pattern-4 shown in FIG. 3 and receives the ACK frame for the Probe Response frame with the four patterns, that is, the directivity pattern-1 to directivity pattern-4.

The signal processor 113 calculates, for each of the directivity patterns specified by the directivity pattern specifying unit 112, an RSSI (received signal strength indicator) which indicates a radio wave intensity, based on the ACK frame transmitted from the wireless terminal 20.

FIG. 3 is a sequence diagram showing how the communication system according to the first embodiment operates.

At first, at step S101, the communication unit 111 of the radio base station 110 receives a Probe Request frame that the wireless terminal 20 sends out in performing an active scan to search for a nearby radio base station by sending out frames from the wireless terminal 20. Then, the signal processor 113 of the radio base station 110 acquires a MAC (media access control) address of the wireless terminal 20 from the transmission source address field of the received Probe Request frame. The signal processor 113 passes the acquired MAC address of the wireless terminal 20 to the directivity pattern specifying unit 112.

Then, the directivity pattern specifying unit 112 indicates (specifies) to the communication unit 111 the directivity pattern-1 shown in FIG. 3 and the MAC address of the wireless terminal 20 acquired from the Probe Request frame. After performing back-off process according to the IEEE 802.11 standard, the communication unit 111 sends out, with the directivity pattern-1, a Probe Response frame in which (i) the MAC address of the wireless terminal 20 acquired from the Probe Request frame is set in a destination address field and (ii) a MAC address of the radio base station 110 is set in a transmission source address field (step S102).

If correctly receiving the Probe Response frame directed to the wireless terminal 20, the wireless terminal 20 sends an ACK frame to the radio base station 110 as a delivery acknowledgment response after a prescribed period SIFS (short interframe space) elapses from a time at which the wireless terminal 20 receives the Probe Response frame (at step S103). The communication unit 111 of the radio base station 110 receives the ACK frame directed to the communication unit 111, with the directivity pattern-1. At step S104, the signal processor 113 calculates an RSSI of the ACK frame received with the directivity pattern-1. The signal processor 113 generates relation information-1 including (i) the MAC address of the wireless terminal 20 (ACK frame transmission source) set in the destination address field of the Probe Response frame, (ii) identification information to identify the directivity pattern-1, and (iii) the calculated RSSI. The signal processor 113 sends the generated relation information-1 to the outside (e.g., to a position estimating device (not shown)). Instead, the signal processor 113 may store the generated relation information-1 in the radio base station 110, for example, in a separately provided storage (not shown).

Subsequently, the directivity pattern specifying unit 112 provides the communication unit 111 with the directivity pattern-2 shown in FIG. 3 and the MAC address of the wireless terminal 20 acquired from the Probe Request frame. After performing the back-off process according to the IEEE 802.11 standard, the communication unit 111 sends out, with the directivity pattern-2, a Probe Response frame in which (i) the MAC address of the wireless terminal 20 acquired from the Probe Request frame is set in a destination address field and (ii) the MAC address of the radio base station 110 is set in a transmission source address field (step S105).

If correctly receiving the Probe Response frame directed to the wireless terminal 20, the wireless terminal 20 sends an ACK frame to the radio base station 110 as a delivery acknowledgment response after an SIFS period elapses from a time when the wireless terminal 20 receives the Probe Response frame (step S106). The communication unit 111 of the radio base station 110 receives the ACK frame directed to the radio base station 110, with the directivity pattern-2. At step S107, the signal processor 113 calculates an RSSI of the ACK frame received with the directivity pattern-2. The signal processor 113 generates relation information-2 including (i) the MAC address of the wireless terminal 20 (ACK frame transmission source) set in the destination address field of the Probe Response frame, (ii) identification information to identify the directivity pattern-2, and (iii) the calculated RSSI. The signal processor 113 sends the generated relation information-2 to the outside (e.g., to the position estimating device (not shown)). Instead, the signal processor 113 may store the generated relation information-2 in the radio base station 110, for example, in the separately provided storage (not shown).

Subsequently, the directivity pattern specifying unit 112 indicates (specifies) to the communication unit 111 the directivity pattern-3 shown in FIG. 3 and the MAC address of the wireless terminal 20 acquired from the Probe Request frame. After performing the back-off process according to the IEEE 802.11 standard, the communication unit 111 sends out, with the directivity pattern-3, a Probe Response frame in which (i) the MAC address of the wireless terminal 20 acquired from the Probe Request frame is set in a destination address field and (ii) the MAC address of the radio base station 110 is set in a transmission source address field (step S108).

If correctly receiving the Probe Response frame directed to the wireless terminal 20, the wireless terminal 20 sends an ACK frame to the radio base station 110 as a delivery acknowledgment response after an SIFS period elapses from a time at which the terminal 20 receives the Probe Response frame (step S109). The communication unit 111 of the radio base station 110 receives the ACK frame directed to the radio base station 110, with the directivity pattern-3. At step S110, the signal processor 113 calculates an RSSI of the ACK frame received with the directivity pattern-3. The signal processor 113 generates relation information-3 including (i) the MAC address of the wireless terminal 20 (ACK frame transmission source) set in the destination address field of the Probe Response frame, (ii) identification information to identify the directivity pattern-3, and (iii) the calculated RSSI. The signal processor 113 sends the generated relation information-3 to the outside (e.g., to the position estimating device (not shown)). Instead, the signal processor 113 may store the generated relation information-3 in the radio base station 110, for example, in the separately provided storage (not shown).

Subsequently, the directivity pattern specifying unit 112 indicates (specifies) to the communication unit 111 the directivity pattern-4 shown in FIG. 3 and the MAC address of the wireless terminal 20 acquired from the Probe Request frame. After performing the back-off process according to the IEEE 802.11 standard, the communication unit 111 sends out, with the directivity pattern-4, a Probe Response frame in which (i) the MAC address of the wireless terminal 20 acquired from the Probe Request frame is set in a destination address field and (ii) the MAC address of the radio base station 110 is set in a transmission source address field (step S111).

If correctly receiving the Probe Response frame directed to the wireless terminal 20, the wireless terminal 20 sends an ACK frame to the radio base station 110 as a delivery acknowledgment response after an SIFS period elapses from a time when the terminal 20 receives the Probe Response frame (step S112). The communication unit 111 of the radio base station 110 receives the ACK frame directed to the radio base station 110, with the directivity pattern-4. At step S113, the signal processor 113 calculates an RSSI of the ACK frame received with the directivity pattern-4. The signal processor 113 generates relation information-4 including (i) the MAC address of the wireless terminal 20 which is the destination of the Probe Response frame and is the ACK frame transmission source, (ii) identification information to identify the directivity pattern-4, and (iii) the calculated RSSI. The signal processor 113 sends the generated relation information-4 to the outside (e.g., to the position estimating device (not shown)). Instead, the signal processor 113 may store the generated relation information-4 in the radio base station 110, for example, in a separately provided storage (not shown).

The acquired four relation information can be used for, for example, estimation of a position of the wireless terminal 20.

In the first embodiment, as described above, the radio base station 110 can acquire four RSSIs by sending out a Probe Response frame with four directivity patterns and receiving, with the four directivity patterns, an ACK frame which is a delivery acknowledgement response to the Probe Response frame. IEEE 802.11 prescribes that when receiving a Probe Response frame sent from a radio base station, a wireless terminal should return an ACK frame as acknowledgement after an SIFS period elapses. Therefore, the radio base station 110 can acquire plural RSSIs at a desired timing according to controls performed by the radio base station. The exchange of a Probe Request frame, a Probe Response frame, and an ACK frame is done in an active scan according to IEEE 802.11 which is performed before establishment of a connection between the wireless terminal 20 and the radio base station 110. Therefore, the radio base station 110 can acquire RSSIs from the wireless terminal 20 with which a connection has not been established yet, without a new function being added to the wireless terminal 20.

In the first embodiment, the communication unit 111 sends out a Probe Response frame four times while switching between the directivity pattern-1 to the directivity pattern-4 according to instructions from the directivity pattern specifying unit 112 and receives an ACK frame for the communication unit four times also with the directivity pattern-1 to the directivity pattern-4. Alternatively, the communication unit 111 may switch between the directivity pattern-1 to the directivity pattern-4 only in receiving an ACK frame.

The first embodiment is directed to the example communication system having one radio base station and one wireless terminal. It should be noted, however, that the concept of the first embodiment is applicable to a communication system having plural radio base stations or plural wireless terminals.

### Modification of Embodiment 1

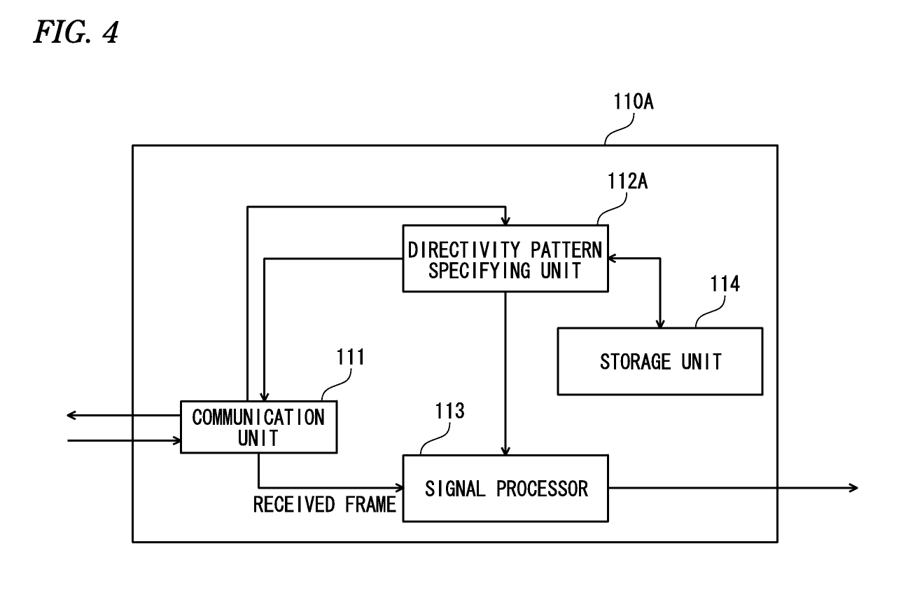

FIG. 4 is a block diagram of a radio base station 110A according to a modification of the first embodiment.

The radio base station 110A is different from the radio base station 110 in that a directivity pattern specifying unit 112A and a storage unit 114 are provided in place of the directivity pattern specifying unit 112.

The storage unit 114 stores a set of directivity patterns to be used for the each communication terminal so that the set of directivity patterns is associated with a MAC address of each wireless terminal. For example, the storage unit 114 stores the directivity pattern-1 to the directivity pattern-4 so that the directivity pattern-1 to directivity pattern-4 are associated with the MAC address identifying the wireless terminal 20. The storage unit 114 may store sets of directivity patterns to be used in such a manner that the sets of directivity patterns are associated with MAC addresses of wireless terminals other than the wireless terminal 20.

The directivity pattern specifying unit 112A refers to the storage unit 114 and instructs the communication unit 111 to perform communication using plural directivity patterns corresponding to a MAC address in the transmission source address field of a Probe Request frame.

The radio base station 110A functions and operates in the same manners as the radio base station 110.

Like the first embodiment, this modification is basically directed to the example communication system having one radio base station and one wireless terminal. It should be noted, however, that the concept of this modification is applicable to a communication system having plural radio base stations or plural wireless terminals.

### Second Embodiment

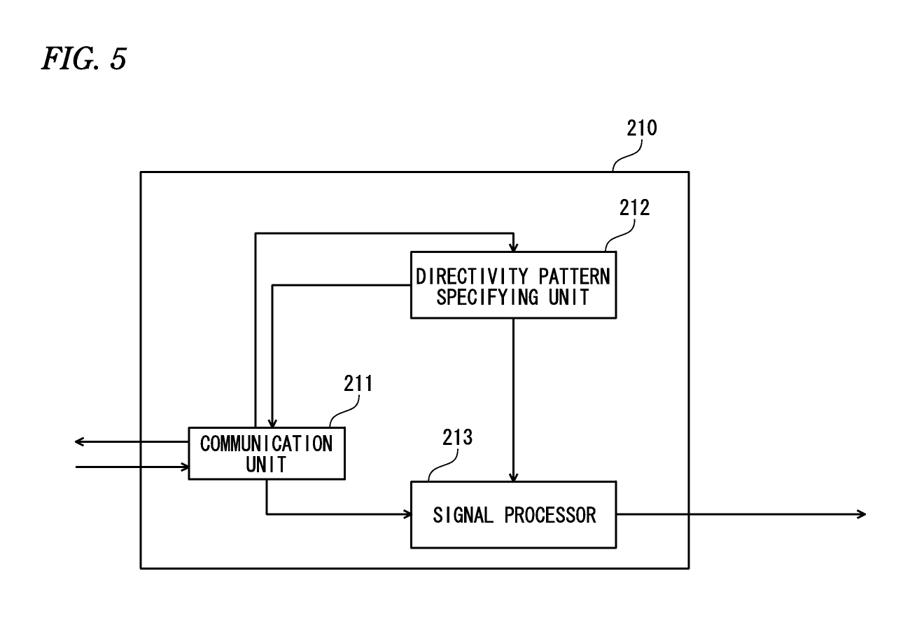

Next, a radio base station 210 according to a second embodiment will be described. FIG. 5 is a block diagram of the radio base station 210 according to the second embodiment. A communication system according to the second embodiment will not be described in detail because it is different from the communication system according to the first embodiment only in that the radio base station 210 replaces the radio base station 110.

Unlike the radio base station 110, the radio base station 210 calculates plural RSSIs by sending a Probe Response frame to the wireless terminal 20 only one time and multiplying a response ACK frame by plural weight matrices. Specifically, a communication unit 211, a directivity pattern specifying unit 212, and a signal processor 213 are different in function from the communication unit 111, the directivity pattern specifying unit 112, and the signal processor 113, respectively.

The communication unit 211 sends a Probe Response frame as a response to a Probe Request frame to the wireless terminal 20 with a non-directional directivity pattern. Also, the communication unit 211 receives an ACK frame for the Probe Response frame from the wireless terminal 20 with a non-directional directivity pattern.

The directivity pattern specifying unit 212 indicates (specifies) to the signal processor 213 weight matrices (corresponding to respective directivity patterns) which is to be multiplied by an ACK frame.

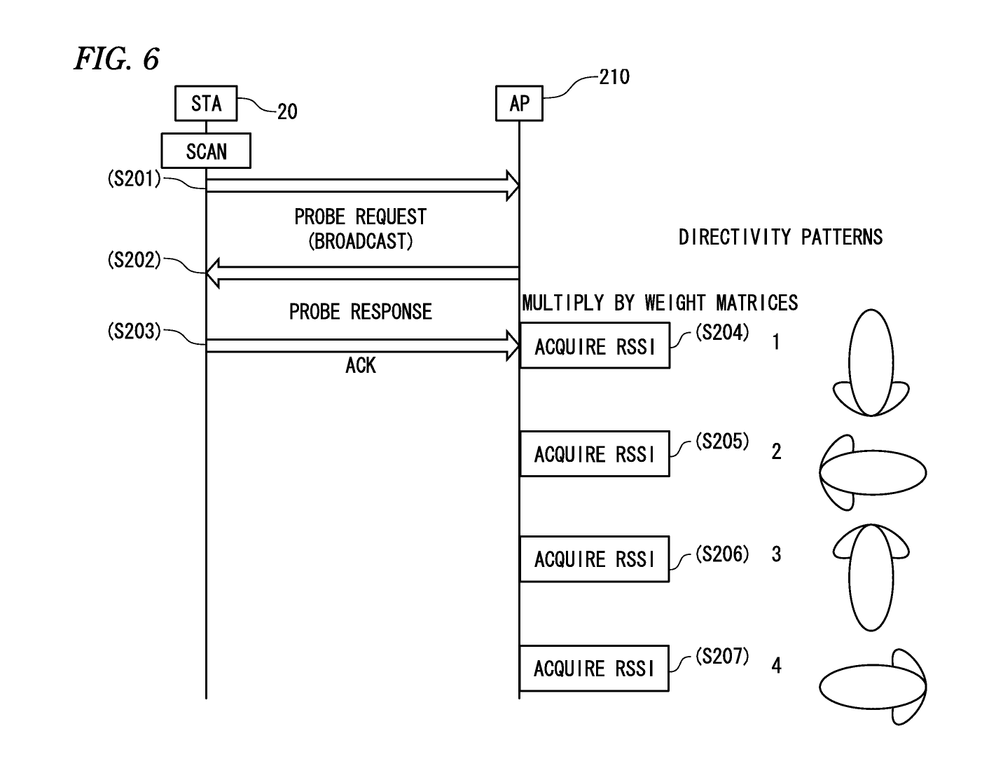

The signal processor 213 calculates plural RSSIs by multiplying a received ACK frame by the respective weight matrices specified by the directivity pattern specifying unit 212. FIG. 6 is a sequence diagram showing how the communication system according to the second embodiment operates.

At first, at step S201, the communication unit 211 of the radio base station 210 receives a Probe Request frame that the wireless terminal 20 sends out in performing an active scan. The signal processor 213 of the radio base station 210 acquires a MAC address of the wireless terminal 20 from a transmission source address field of the received Probe Request frame. The signal processor 213 passes the acquired MAC address of the wireless terminal 20 to the communication unit 211.

After performing the back-off process according to the IEEE 802.11 standard, the communication unit 111 sends, to the wireless terminal 20, a Probe Response frame in which (i) the MAC address of the wireless terminal 20 acquired from the Probe Request frame at step S201 is set in a destination address field and (ii) a MAC address of the radio base station 210 is set in a transmission source address field (step S202).

If correctly receiving the Probe Response frame directed to the wireless terminal 20, the wireless terminal 20 sends an ACK frame to the radio base station 210 as a delivery acknowledgment response after an SIFS period elapses from a time when the terminal 20 receives the Probe Response frame (step S203).

Receiving the ACK frame, the radio base station 210 stores the ACK frame in the signal processor 213.

At step S204, the signal processor 213 calculates an RSSI by multiplying the ACK frame signal stored in the signal processor 213 by a weight matrix corresponding to a directivity pattern-1 according to an instruction (specifying) from the directivity pattern specifying unit 212. Then, the signal processor 213 sends, to the outside (e.g., to a position estimating device (not shown)), relation information-1 including (i) the MAC address of the wireless terminal 20 (ACK frame transmission source) set in the destination address field of the Probe Response frame, (ii) identification information to identify the directivity pattern-1, and (iii) the calculated RSSI of the ACK frame. Alternatively, the signal processor 213 may store the generated relation information-1 in the radio base station 210, for example, in a separately provided storage (not shown).

At step S205, the signal processor 213 calculates an RSSI by multiplying the same ACK frame signal stored in the signal processor 213 as used at step S204 by a weight matrix corresponding to a directivity pattern-2 according to an instruction (specifying) from the directivity pattern specifying unit 212. Then, the signal processor 213 sends, to the outside (e.g., to the position estimating device (not shown)), relation information-2 including (i) the MAC address of the wireless terminal 20 (ACK frame transmission source) set in the destination address field of the Probe Response frame, (ii) identification information to identify the directivity pattern-2, and (iii) the calculated RSSI of the ACK frame. Alternatively, the signal processor 213 may store the generated relation information-2 in the radio base station 210, for example, in a separately provided storage (not shown).

At step S206, the signal processor 213 calculates an RSSI by multiplying the same ACK frame signal stored in the signal processor 213 as used at step S204 by a weight matrix corresponding to a directivity pattern-3 according to an instruction (specifying) from the directivity pattern specifying unit 212. Then, the signal processor 213 sends, to the outside (e.g., to the position estimating device (not shown)), relation information-3 including (i) the MAC address of the wireless terminal 20 (ACK frame transmission source) set in the destination address field of the Probe Response frame, (ii) identification information to identify the directivity pattern-3, and (iii) the calculated RSSI of the ACK frame. Alternatively, the signal processor 213 may store the generated relation information-3 in the radio base station 210, for example, in a separately provided storage (not shown).

At step S207, the signal processor 213 calculates an RSSI by multiplying the same ACK frame signal stored in the signal processor 213 as used at step S204 by a weight matrix corresponding to a directivity pattern-4 according to an instruction (specifying) from the directivity pattern specifying unit 212. Then, the signal processor 213 sends, to the outside (e.g., to the position estimating device (not shown)), relation information-4 including (i) the MAC address of the wireless terminal 20 (ACK frame transmission source) set in the destination address field of the Probe Response frame, (ii) identification information to identify the directivity pattern-4, and (iii) the calculated RSSI of the ACK frame. Alternatively, the signal processor 213 may store the generated relation information-4 in the radio base station 210, for example, in a separately provided storage (not shown).

The acquired four relation information can be used for, for example, estimation of a position of the wireless terminal 20.

According to the second embodiment, the signal processor 213 multiplies the ACK frame for the Probe Response frame by the weight matrices corresponding to the plural respective directivity patterns. Therefore, the radio base station 210 can acquire the plural RSSIs by performing a single exchange of the Probe Response frame and the ACK frame. The IEEE 802.11 standard prescribes that when receiving a Probe Response frame sent from a radio base station, a wireless terminal should return an ACK frame as a delivery acknowledgement response after an SIFS period elapses. Therefore, the radio base station 210 can acquire plural RSSIs at a desired timing according to controls performed by the radio base station 210 without a new function being added to the wireless terminal 20. The exchange of a Probe Request frame, a Probe Response frame, and an ACK frame is done in an active scan according to IEEE 802.11 which is performed before establishment of a connection between the wireless terminal 20 and the radio base station 210. Therefore, the radio base station 110 can acquire RSSIs even for the wireless terminal 20 with which a connection has not been established yet.

Like the first embodiment, the second embodiment is directed to the example communication system having one radio base station and one wireless terminal. It should be noted, however, that the concept of the second embodiment is applicable to a communication system having plural radio base stations or plural wireless terminals.

### Third Embodiment

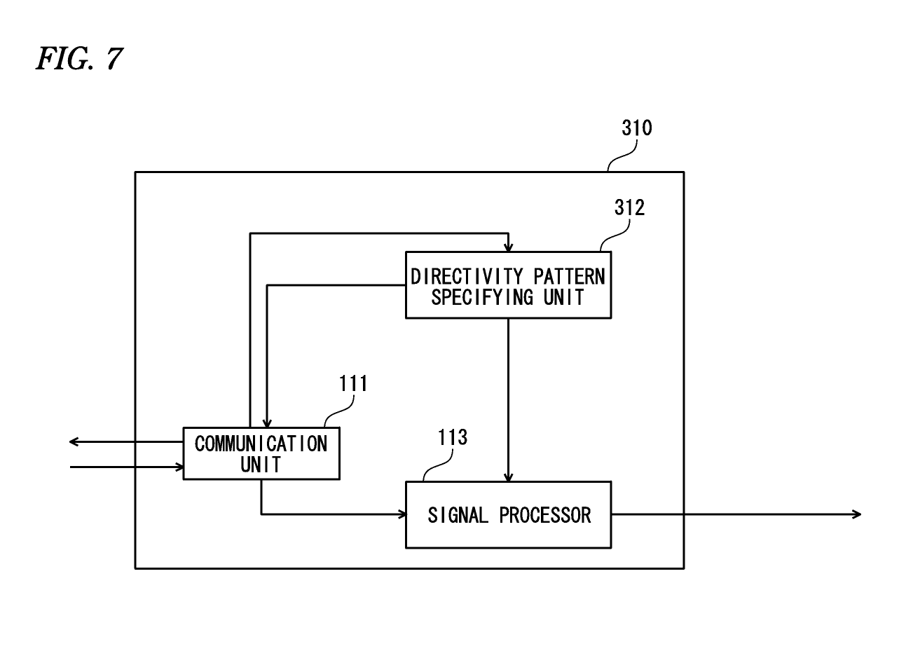

Next, a radio base station 310 according to a third embodiment will be described. FIG. 7 is a block diagram of the radio base station 310 according to the third embodiment. A communication system according to the third embodiment will not be described in detail because it is different from the communication system according to the first embodiment only in that the radio base station 310 replaces the radio base station 110.

The radio base station 310 is different from the radio base station 110 in that the radio base station 310 sets, for respective directivity patterns, different MAC addresses (as transmission source addresses) in respective Probe Response frames. The different MAC addresses may be plural virtual MAC addresses. In the third embodiment, it is assumed that the radio base station 310 uses plural virtual MAC addresses. In order to implement this function, a directivity pattern specifying unit 312 of the radio base station 310 according to the third embodiment is different in function from the directivity pattern specifying unit 112 of the radio base station 110 according to the first embodiment.

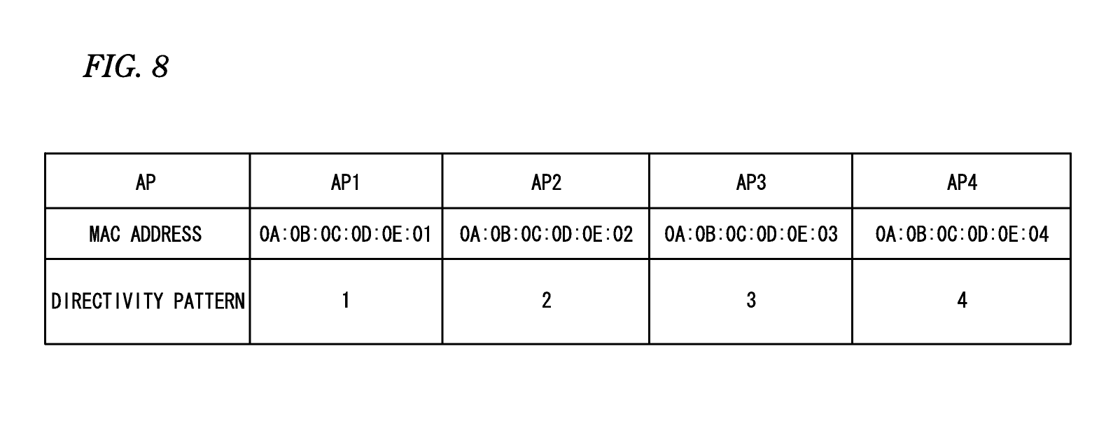

For example, the directivity pattern specifying unit 312 may include a storage (not shown) that stores in advance a correspondence table as shown in FIG. 8 in which directivity patterns are associated with respective MAC addresses. The directivity pattern specifying unit 312 indicates (specifies) to the communication unit 111 a directivity pattern corresponding to a MAC address by referring to the correspondence table.

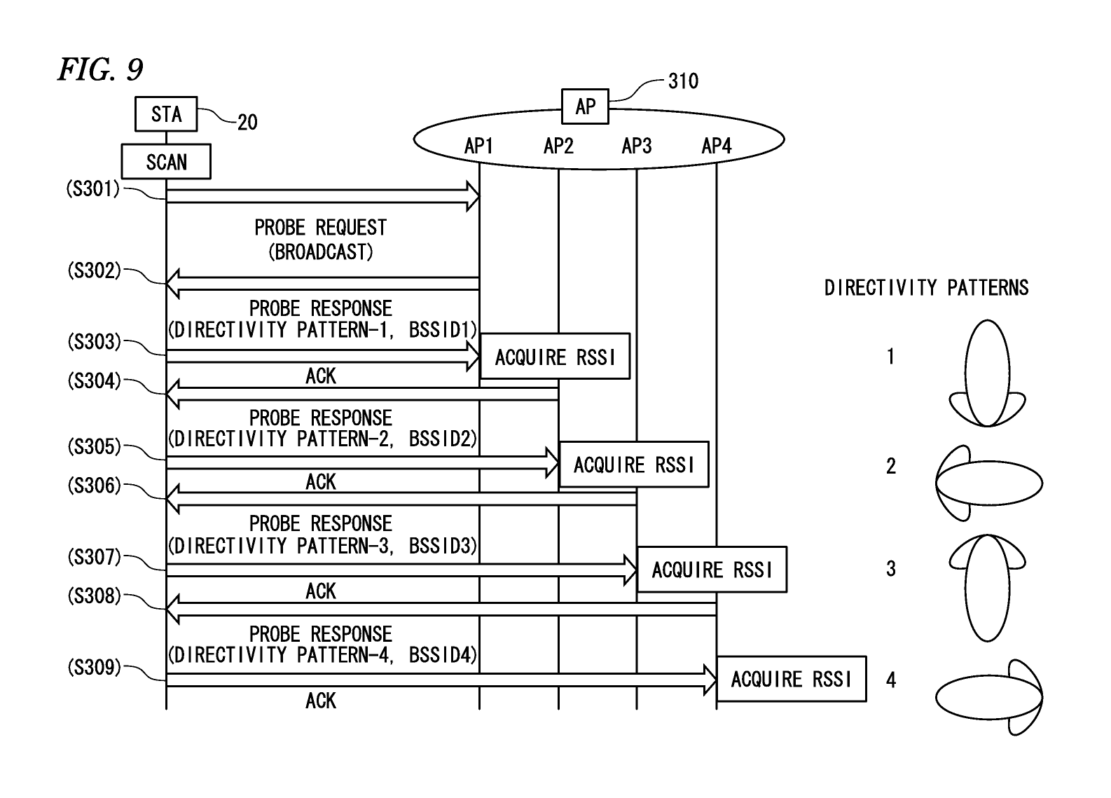

FIG. 9 is a sequence diagram showing how the radio base station 310 and the wireless terminal 20 operate. In FIG. 9, identifiers BSSD1 to BSSD4 of AP1 to AP4 correspond to MAC addresses 0A:0B:0C:0D:0E:01, 0A:0B:0C:0D:0E:02, 0A:0B:0C:0D:0E:03, and 0A:0B:0C:0D:0E:04 shown in FIG. 8, respectively.

At first, at step S301, the communication unit 111 of the radio base station 310 receives a Probe Request frame that the wireless terminal 20 sends out in performing an active scan. Then, the signal processor 113 of the radio base station 310 acquires a MAC address of the wireless terminal 20 from the transmission source address field of the received Probe Request frame. The signal processor 113 passes the acquired MAC address of the wireless terminal 20 to the directivity pattern specifying unit 312.

Then, the directivity pattern specifying unit 312 indicates (specifies) to the communication unit 111 (i) a directivity pattern-1 shown in FIG. 9, (ii) the MAC address “0A:0B:0C:0D:0E:01” corresponding to the directivity pattern-1 (in accordance with the correspondence table shown in FIG. 8), and (iii) the MAC address of the wireless terminal 20 acquired from the Probe Request frame. After performing the back-off process according to the IEEE 802.11 standard, the communication unit 111 sends out, with the directivity pattern-1, a Probe Response frame in which (i) the MAC address of the wireless terminal 20 acquired from the Probe Request frame is set in a destination address field and (ii) the MAC address “0A:0B:0C:0D:0E:01” corresponding to the directivity pattern-1 is set in a transmission source address field (in accordance with the correspondence table shown in FIG. 8; step S302).

If correctly receiving the Probe Response frame directed to the wireless terminal 20, the wireless terminal 20 sends an ACK frame to 0A:0B:0C:0D:0E:01 as a delivery acknowledgment response after an SIFS period elapses from a time when the wireless terminal 20 receives the Probe Response frame (step S303). The communication unit 111 of the radio base station 310 receives the ACK frame directed to 0A:0B:0C:0D:0E:01 with the directivity pattern-1. The signal processor 113 calculates an RSSI of the ACK frame received with the directivity pattern-1. The signal processor 113 generates relation information-1 including (i) the MAC address of the wireless terminal 20 which was the destination of the Probe Response frame and is the ACK frame transmission source, (ii) identification information to identify the directivity pattern-1, and (iii) the calculated RSSI. The signal processor 113 sends the generated relation information-1 to the outside (e.g., to a position estimating device (not shown)). Alternatively, the signal processor 113 may store the generated relation information-1 in the radio base station 310, for example, in a separately provided storage (not shown).

Subsequently, the directivity pattern specifying unit 312 indicates (specifies) to the communication unit 111 (i) a directivity pattern-2 shown in FIG. 9, (ii) the MAC address “0A:0B:0C:0D:0E:02” corresponding to the directivity pattern-2 (in accordance with the correspondence table shown in FIG. 8), and (iii) the MAC address of the wireless terminal 20 acquired from the Probe Request frame. After performing the back-off process according to the IEEE 802.11 standard, the communication unit 111 sends out, with the directivity pattern-2, a Probe Response frame in which (i) the MAC address of the wireless terminal 20 acquired from the Probe Request frame is set in a destination address field and (ii) the MAC address “0A:0B:0C:0D:0E:02” corresponding to the directivity pattern-2 is set in a transmission source address field (in accordance with the correspondence table shown in FIG. 8; step S304).

If correctly receiving the Probe Response frame directed to the wireless terminal 20, the wireless terminal 20 sends an ACK frame to 0A:0B:0C:0D:0E:02 as a delivery acknowledgment response after an SIFS period elapses from a time when the wireless terminal 20 receives the Probe Response frame (step S305). The communication unit 111 of the radio base station 310 receives the ACK frame directed to 0A:0B:0C:0D:0E:02 with the directivity pattern-2. The signal processor 113 calculates an RSSI of the ACK frame received with the directivity pattern-2. The signal processor 113 generates relation information-2 including (i) the MAC address of the wireless terminal 20 which was the destination of the Probe Response frame and is the ACK frame transmission source, (ii) identification information to identify the directivity pattern-2, and (iii) the calculated RSSI. The signal processor 113 sends the generated relation information-2 to the outside (e.g., to the position estimating device (not shown)). Alternatively, the signal processor 113 may store the generated relation information-2 in the radio base station 310, for example, in a separately provided storage (not shown).

Subsequently, the directivity pattern specifying unit 312 indicates (specifies) to the communication unit 111 (i) a directivity pattern-3 shown in FIG. 9, (ii) the MAC address “0A:0B:0C:0D:0E:03” corresponding to the directivity pattern-3 (in accordance with the correspondence table shown in FIG. 8), and (iii) the MAC address of the wireless terminal 20 acquired from the Probe Request frame. After performing the back-off process according to the IEEE 802.11 standard, the communication unit 111 sends out, with the directivity pattern-3, a Probe Response frame in which (i) the MAC address of the wireless terminal 20 acquired from the Probe Request frame is set in a destination address field and (ii) the MAC address “0A:0B:0C:0D:0E:03” corresponding to the directivity pattern-3 is set in a transmission source address field (in accordance with the correspondence table shown in FIG. 8; step S306).

If correctly receiving the Probe Response frame directed to the wireless terminal 20, the wireless terminal 20 sends an ACK frame to 0A:0B:0C:0D:0E:03 as a delivery acknowledgment response after an SIFS period elapses from a time when the receipt of the Probe Response frame (step S307). The communication unit 111 of the radio base station 310 receives the ACK frame directed to 0A:0B:0C:0D:0E:03 with the directivity pattern-3. The signal processor 113 calculates an RSSI of the ACK frame received with the directivity pattern-3. The signal processor 113 generates relation information-3 including (i) the MAC address of the wireless terminal 20 which was the destination of the Probe Response frame and is the ACK frame transmission source, (ii) identification information to identify the directivity pattern-3, and (iii) the calculated RSSI. The signal processor 113 sends the generated relation information-3 to the outside (e.g., to the position estimating device (not shown)). Alternatively, the signal processor 113 may store the generated relation information-3 in the radio base station 310, for example, in a separately provided storage (not shown).

Subsequently, the directivity pattern specifying unit 312 indicates (specifies) to the communication unit 111 (i) a directivity pattern-4 shown in FIG. 9, (ii) the MAC address “0A:0B:0C:0D:0E:04” corresponding to the directivity pattern-4 (in accordance with the correspondence table shown in FIG. 8), and (iii) the MAC address of the wireless terminal 20 acquired from the Probe Request frame. After performing the back-off process according to the IEEE 802.11 standard, the communication unit 111 sends out, with the directivity pattern-4, a Probe Response frame in which (i) the MAC address of the wireless terminal 20 acquired from the Probe Request frame is set in a destination address field and (ii) the MAC address “0A:0B:0C:0D:0E:04” corresponding to the directivity pattern-4 is set in a transmission source address field (step S308).

If correctly receiving the Probe Response frame directed to the wireless terminal 20, the wireless terminal 20 sends an ACK frame to 0A:0B:0C:0D:0E:04 as a delivery acknowledgment response after an SIFS period elapses from a time when the wireless terminal 20 receives the Probe Response frame (step S309). The communication unit 111 of the radio base station 310 receives the ACK frame directed to 0A:0B:0C:0D:0E:04 with the directivity pattern-4. The signal processor 113 calculates an RSSI of the ACK frame received with the directivity pattern-4. The signal processor 113 generates relation information-4 including (i) the MAC address of the wireless terminal 20 which was the destination of the Probe Response frame and is the ACK frame transmission source, (ii) identification information to identify the directivity pattern-4, and (iii) the calculated RSSI. The signal processor 113 sends the generated relation information-4 to the outside (e.g., to the position estimating device (not shown)). Alternatively, the signal processor 113 may store the generated relation information-4 in the radio base station 310, for example, in a separately provided storage (not shown).

The acquired four relation information can be used for, for example, estimation of a position of the wireless terminal 20.

In the third embodiment, the radio base station 310 send out Probe Response frames in such a manner that different MAC addresses which are assigned to respective directivity patterns are set in transmission source address fields of the Probe Response frames. That is, to the wireless terminal 20, one Probe Response frame is transmitted to each transmission source address. Thus, the wireless terminal 20 sends an ACK frame to each transmission source address according to the IEEE 802.11 standard. Therefore, the radio base station 310 can acquire RSSIs for plural directivity patterns without a new function being added to the wireless terminal 20.

The radio base station 310 can provide the same advantages as the radio base station 110 according to the first embodiment.

Like the first embodiment, the third embodiment is directed to the example communication system having one radio base station and one wireless terminal. It should be noted, however, that the concept of the third embodiment is applicable to a communication system having plural radio base stations or plural wireless terminals.

### Fourth Embodiment

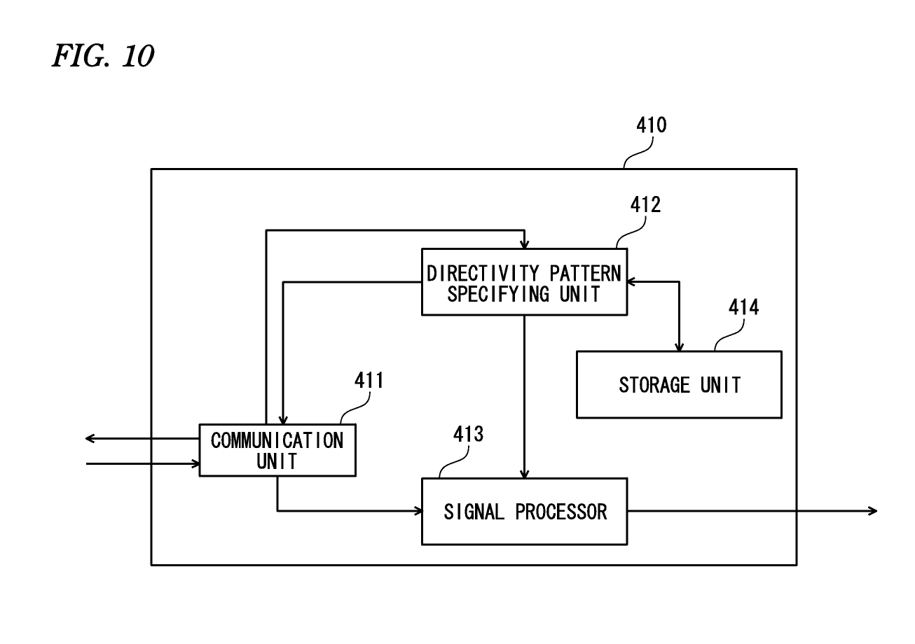

Next, a radio base station 410 according to a fourth embodiment will be described. FIG. 10 is a block diagram of the radio base station 410 according to the fourth embodiment. A communication system according to the fourth embodiment will not be described in detail because it is different from the communication system according to the first embodiment only in that the radio base station 410 replaces the radio base station 110.

The radio base station 410 is different from the radio base station 110 in that the radio base station 410 acquires RSSIs for different directivity patterns by (i) sending a Probe Response frame and an Authentication frame to the wireless terminal 20 with the respective directivity patterns and (ii) receiving ACK frames for the Probe Response frame and the Authentication frame with the different directivity patterns. That is, the radio base station 410 acquires plural RSSIs by sending different types of frames with different directivity patterns and then receiving ACK frames with the different directivity patterns.

After the wireless terminal 20 and the radio base station 410 exchange a Probe Request frame, a Probe Response frame, and an ACK frame in the wireless terminal 20's performing an active scan to search for a radio base station (as described in the first embodiment; a wireless communication exchange according to IEEE 802.11), the wireless terminal 20 and the radio base station 410 exchange Authentication frames to perform authentication (also a wireless communication exchange according to IEEE 802.11). In the fourth embodiment, the radio base station 410 acquires RSSIs from the wireless terminal 20 with plural directivity patterns in performing a signal exchange by which the wireless terminal 20 searches for a radio base station and a signal exchange for authentication which is part of a procedure for establishing a connection link between the wireless terminal 20 and the radio base station 410.

The radio base station 410 includes a storage unit 414, and a communication unit 411, a directivity pattern specifying unit 412, and a signal processor 413 are different in function from the communication unit 111, the directivity pattern specifying unit 112, and the signal processor 113 of the radio base station 110, respectively.

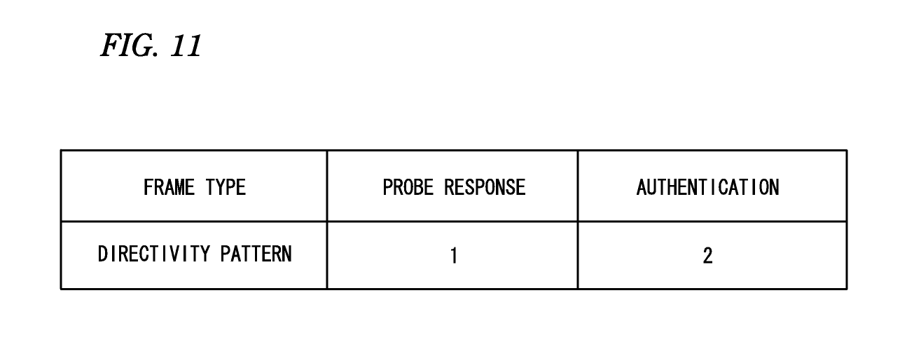

As shown in FIG. 11, the storage unit 414 stores directivity patterns in such a manner that the directivity patterns are associated with respective frame types. The directivity pattern specifying unit 412 refers to the storage unit 414 and indicates (specifies) to the communication unit 411 to perform communication with a directivity pattern that is set in advance for each frame type. In order to communicate a Probe Response frame, the directivity pattern specifying unit 412 may indicate (specify) to the communication unit 411 either plural different directivity patterns or a single directivity pattern. In the fourth embodiment, it is assumed that the directivity pattern specifying unit 412 indicates (specifies) to the communication unit 411 a single directivity pattern.

The communication unit 411 communicates with the wireless terminal 20. The communication unit 411 sends a Probe Response frame and receives an ACK frame (which is a delivery acknowledgment response to the Probe Response frame) with a directivity pattern specified by the directivity pattern specifying unit 412. Then, the communication unit 411 sends an Authentication frame and receives an ACK frame (which is a delivery acknowledgment response to the Authentication frame) with a directivity pattern, which is specified by the directivity pattern specifying unit 412 by referring to the storage unit 414 and which is different from the directivity pattern which was used for sending the Probe Response frame and receiving the ACK frame for the Probe Response frame. A method by which the communication unit 411 realizes the plural directivity patterns is the same as in the first embodiment.

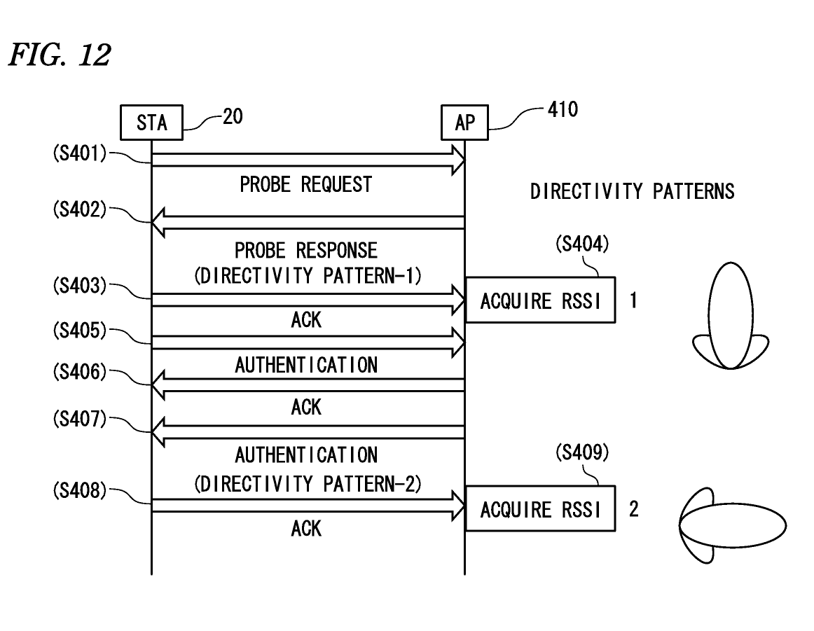

FIG. 12 is a sequence diagram showing how the communication system according to the fourth embodiment operates.

At first, at step S401, the communication unit 111 of the radio base station 410 receives a Probe Request frame that the wireless terminal 20 sends out in performing an active scan. The signal processor 413 of the radio base station 410 acquires a MAC address of the wireless terminal 20 from the transmission source address field of the received Probe Request frame. The signal processor 413 passes the acquired MAC address of the wireless terminal 20 to the directivity pattern specifying unit 412.

Then, the directivity pattern specifying unit 412 indicates (specifies) to the communication unit 411 (i) a directivity pattern-1 (obtained by referring to the table shown in FIG. 11) and (ii) the MAC address of the wireless terminal 20 acquired from the Probe Request frame. After performing the back-off process according to the IEEE 802.11 standard, the communication unit 411 sends out, with the directivity pattern-1, a Probe Response frame in which (i) the MAC address of the wireless terminal 20 that was set in the Probe Request frame is set in a destination address field and (ii) a MAC address of the radio base station 410 is set in a transmission source address field (step S402).

If correctly receiving the Probe Response frame directed to the wireless terminal 20, the wireless terminal 20 sends an ACK frame to the radio base station 410 as a delivery acknowledgment response after an SIFS period elapses from a time when the wireless terminal 20 receives the Probe Response frame (step S403). The communication unit 411 of the radio base station 410 receives the ACK frame directed to the radio base station 410 with the directivity pattern-1. At step S404, the signal processor 413 calculates an RSSI of the ACK frame received with the directivity pattern-1. The signal processor 413 generates relation information-1 including (i) the MAC address of the wireless terminal 20 that was the destination of the Probe Response frame and is the ACK frame transmission source, (ii) identification information to identify the directivity pattern-1, and (iii) the calculated RSSI. The signal processor 413 sends the generated relation information-1 to the outside (e.g., to a position estimating device (not shown)). Alternatively, the signal processor 413 may store the generated relation information-1 in the radio base station 410, for example, in a separately provided storage (not shown).

Subsequently, in order to request establishment of a connection, after performing the back-off process according to the IEEE 802.11 standard, the wireless terminal 20 sends to the radio base station 410 an Authentication frame in which (i) the MAC address of the radio base station 410 is set in a destination address field and (ii) the MAC address of the wireless terminal 20 is set in a transmission source address field (step S405). If correctly receiving the Authentication frame which is directed to the radio base station 410, the communication unit 411 of the radio base station 410 sends an ACK frame to the wireless terminal 20 as a delivery acknowledgment response after an SIFS period elapses from a time when the communication unit 411 receives the Authentication frame, and notifies to the directivity pattern specifying unit 412 of the MAC address of the wireless terminal 20 acquired from the transmission source address of the Authentication frame (step S406).

Then, the directivity pattern specifying unit 412 indicates (specifies) to the communication unit 411 a directivity pattern-2 (obtained by referring to the correspondence table shown in FIG. 11) and the MAC address of the wireless terminal 20, which is acquired from the Authentication frame at step S405.

After performing the back-off process according to the IEEE 802.11 standard, the communication unit 411 of the radio base station 410 sends to the wireless terminal 20 with the directivity pattern-2 an Authentication frame in which (i) the MAC address of the wireless terminal 20 is set in a destination address field and (ii) the MAC address of the radio base station 410 is set in a transmission source address field (step S407).

If correctly receiving the Authentication frame directed to the wireless terminal 20, the wireless terminal 20 sends an ACK frame to the radio base station 410 as a delivery acknowledgment response after an SIFS period elapses from a time when the wireless terminal 20 receives the Authentication frame (step S408).

The communication unit 411 of the radio base station 410 receives the ACK frame directed to the radio base station 410 with the directivity pattern-2. At step S409, the signal processor 413 calculates an RSSI of the ACK frame received with the directivity pattern-2. The signal processor 413 generates relation information-2 including (i) the MAC address of the wireless terminal 20 (ACK frame transmission source) set in the destination address field of the Authentication frame which is sent at S407, (ii) identification information to identify the directivity pattern-2, and (iii) the calculated RSSI. The signal processor 413 sends the generated relation information-2 to the outside (e.g., to the position estimating device (not shown)). Alternatively, the signal processor 413 may store the generated relation information-2 in the radio base station 410, for example, in a separately provided storage (not shown).

The acquired two relation information can be used for, for example, estimation of a position of the wireless terminal 20.

In the fourth embodiment, as described above, the radio base station 410 can acquire two RSSIs by (i) sending out a Probe Response frame and an Authentication frame with different directivity patterns and (ii) receiving, with the two directivity patterns, ACK frames which are delivery acknowledgement responses to the Probe Response frame and the Authentication frame. As described above, the exchanges of a Probe Request frame, a Probe Response frame, Authentication frames, and ACK frames which are performed between the radio base station 410 and the wireless terminal 20 are wireless communication exchanges according to IEEE 802.11. Therefore, RSSIs can be acquired with plural respective directivity patterns in the wireless terminal 20's performing an active scan and in authentication process performed between the wireless terminal 20 and the radio base station 410, without a new function being added to the wireless terminal 20.

Furthermore, the IEEE 802.11 standard prescribes that when receiving a Probe Response frame or an Authentication frame sent from a radio base station, a wireless terminal should return an ACK frame after an SIFS period elapses. Therefore, the radio base station 410 can acquire plural RSSIs at a desired timing according to controls performed by the radio base station 410.

Like the first embodiment, the fourth embodiment is directed to the example communication system having one radio base station and one wireless terminal. It should be noted, however, that the concept of the fourth embodiment is applicable to a communication system having plural radio base stations or plural wireless terminals.

### Modification of Embodiment 4

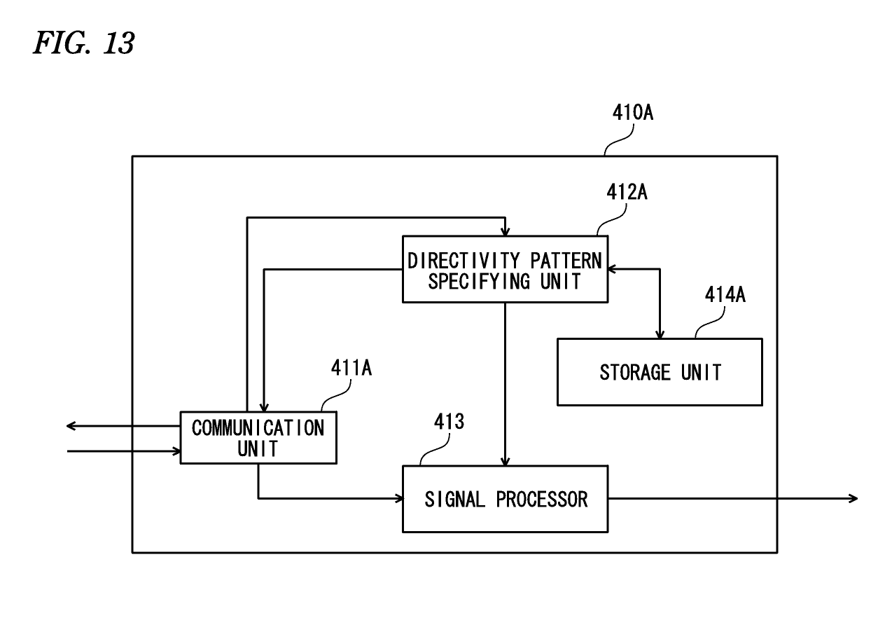

Next, a radio base station 410A according to a modification of the fourth embodiment will be described. FIG. 13 is a block diagram of the radio base station 410A according to the modification of the fourth embodiment.

In addition to the functions of the radio base station 410, The radio base station 410A has functions of acquiring an RSSI in establishing a connection with the wireless terminal 20 after completion of authentication by (i) sending an Association Response frame which is a connection response frame to the wireless terminal 20 with a directivity pattern that is different from those for a Probe Response frame and an Authentication frame and (ii) receiving an ACK frame for the Association Response with this directivity pattern.

After completion of the authentication described in the fourth embodiment, a connection is established between the radio base station 410A and the wireless terminal 20 by exchanging an Association Request frame (connection request frame), an Association Response frame, and an ACK frame. In this modification, the radio base station 410A acquires plural RSSIs for the wireless terminal 20 with plural directivity patterns in the wireless terminal 20's performing an active scan and in the authentication process and connection process which are performed between the wireless terminal 20 and the radio base station 410A.

A communication unit 411A and a directivity pattern specifying unit 412A of the radio base station 410A are different from the communication unit 411 and the directivity pattern specifying unit 412 of the radio base station 410 in that new functions are added to the communication unit 411A and the directivity pattern specifying unit 412A.

In addition to the functions of the directivity pattern specifying unit 412, the directivity pattern specifying unit 412A has a function of instructing the communication unit 411A to communicate an Association Request frame with a directivity pattern that is different those for a Probe Response frame and an Authentication frame.

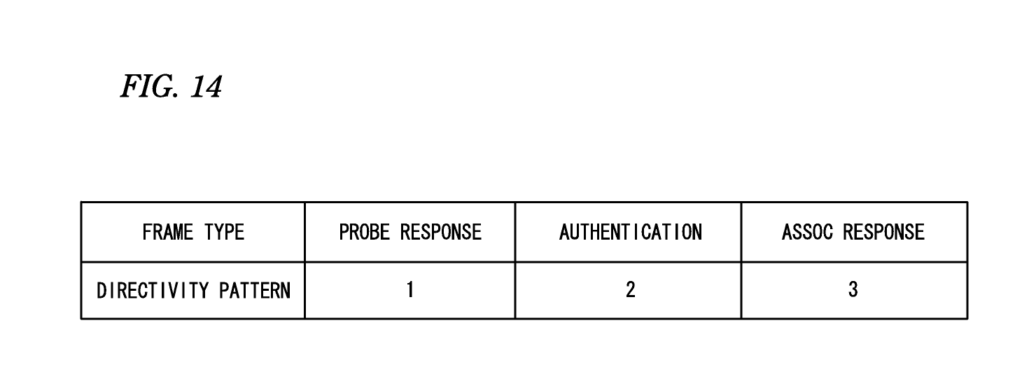

As shown in FIG. 14, a storage unit 414A stores directivity patterns in such a manner that the directivity patterns are associated with respective frame types. The directivity pattern specifying unit 412A refers to the storage unit 414A and instructs the communication unit 411A to perform communication with a directivity pattern that is set in advance for each frame type.

The communication unit 411A communicates with the wireless terminal 20. In addition to the functions of the communication unit 411, the communication unit 411A has functions of (i) sending an Association Request frame with a directivity pattern-3 which is specified by the directivity pattern specifying unit 412A and (ii) receiving an ACK frame for the Association Request frame with the directivity pattern-3.

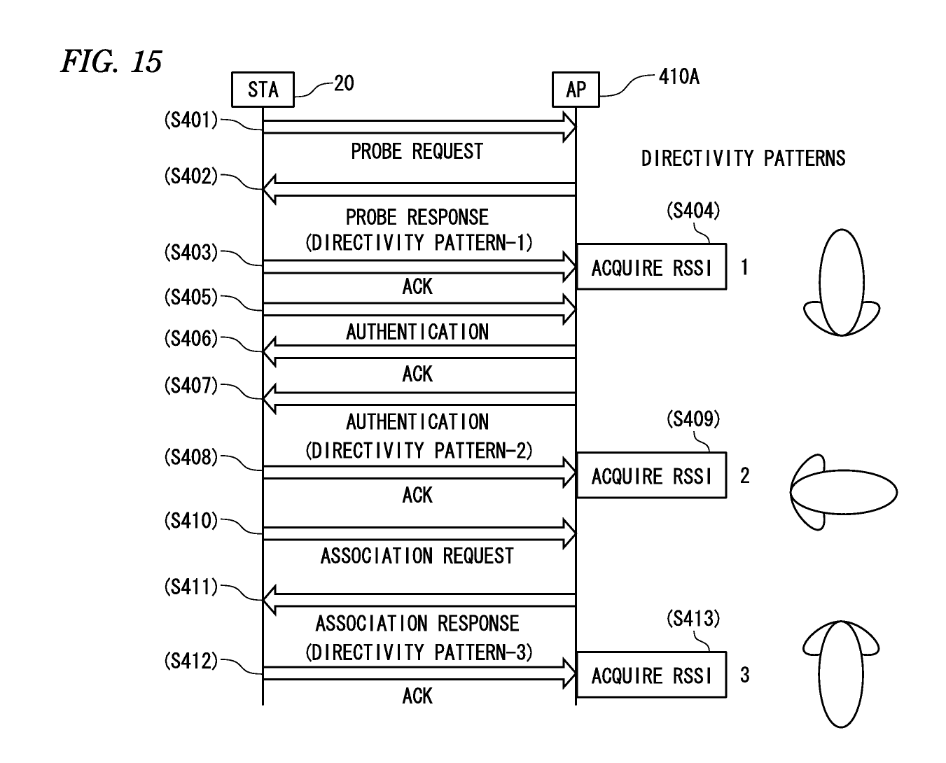

FIG. 15 is a sequence diagram showing how the radio base station 410A according to the modification of the fourth embodiment operates. Steps S401 to S409 are the same as shown in FIG. 12. Therefore, redundant description on those steps will be omitted.

At step S410, the communication unit 411A of the radio base station 410A receives an Association Request frame that the wireless terminal 20 sends out in requesting establishment of a connection. Then, the signal processor 413 of the radio base station 410A acquires a MAC address of the wireless terminal 20 from the transmission source address field of the received Association Request frame. The signal processor 413 passes the acquired MAC address of the wireless terminal 20 to the directivity pattern specifying unit 412A.

Then, the directivity pattern specifying unit 412A indicates (specifies) to the communication unit 411A (i) the directivity pattern-3 (obtained by referring to the table shown in FIG. 14) and (ii) the MAC address of the wireless terminal 20 acquired from the Association Request frame. After performing the back-off process according to the IEEE 802.11 standard, the communication unit 411A sends out, with the directivity pattern-3, a Association Response frame in which (i) the MAC address of the wireless terminal 20 is set in a destination address field and (ii) a MAC address of the radio base station 410A is set in a transmission source address field (step S411).

If correctly receiving the Association Response frame directed to the wireless terminal 20, the wireless terminal 20 sends an ACK frame to the radio base station 410A as a delivery acknowledgment response after an SIFS period elapses from a time when the wireless terminal 20 receives the Association Response frame (step S412). The communication unit 411A of the radio base station 410A receives the ACK frame directed to the radio base station 410A with the directivity pattern-3. At step S413, the signal processor 413 calculates an RSSI of the ACK frame received with the directivity pattern-3. The signal processor 413 generates relation information-3 including (i) the MAC address of the wireless terminal 20 (ACK frame transmission source) set in the transmission source address frame of the Association Request frame and is the ACK frame transmission source, (ii) identification information to identify the directivity pattern-3, and (iii) the calculated RSSI. The signal processor 413 sends the generated relation information-3 to the outside (e.g., to the position estimating device (not shown)). Alternatively, the signal processor 413 may store the generated relation information-3 in the radio base station 410A, for example, in a separately provided storage (not shown).

The acquired relation information-3 can be used for, for example, estimation of a position of the wireless terminal 20 together with the relation information-1 and the relation information-2.

In this modification, as described above, the radio base station 410A can acquire plural RSSIs by (i) sending out an Association Response frame with a directivity pattern that is different from those for a Probe Response frame and an Authentication frame and (ii) receiving, with the same directivity pattern, an ACK frame which is a delivery acknowledgement response to the Association Response frame. As described above, the exchange of an Association Request frame, an Association Response frame, and an ACK frame which is performed between the radio base station 410A and the wireless terminal 20 is a wireless communication exchange according to IEEE 802.11. Therefore, RSSIs can be acquired with plural respective directivity patterns in performing operations according to the IEEE 802.11 standard, without a new function being added to the wireless terminal 20. Furthermore, the IEEE 802.11 standard prescribes that when receiving an Association Response frame sent from a radio base station, a wireless terminal should return an ACK frame after an SIFS period elapses. Therefore, the radio base station 410A can acquire plural RSSIs at a desired timing according to controls performed by the radio base station 410A.

Instead of sending all of a Probe Response frame, an Authentication frame, and an Association Response frame with different directivity patterns and receiving ACK frames for those frames with the different directivity patterns, the radio base station 410A may calculate RSSIs for two respective different directivity patterns by (i) sending only two of a Probe Response frame, an Authentication frame, and an Association Response frame with different directivity patterns and (ii) receiving ACK frames for the two of them with the different directivity patterns.

Like the first embodiment, this modification is directed to the example communication system having one radio base station and one wireless terminal. It should be noted, however, that the concept of the embodiment is applicable to a communication system having plural radio base stations or plural wireless terminals.

### Fifth Embodiment

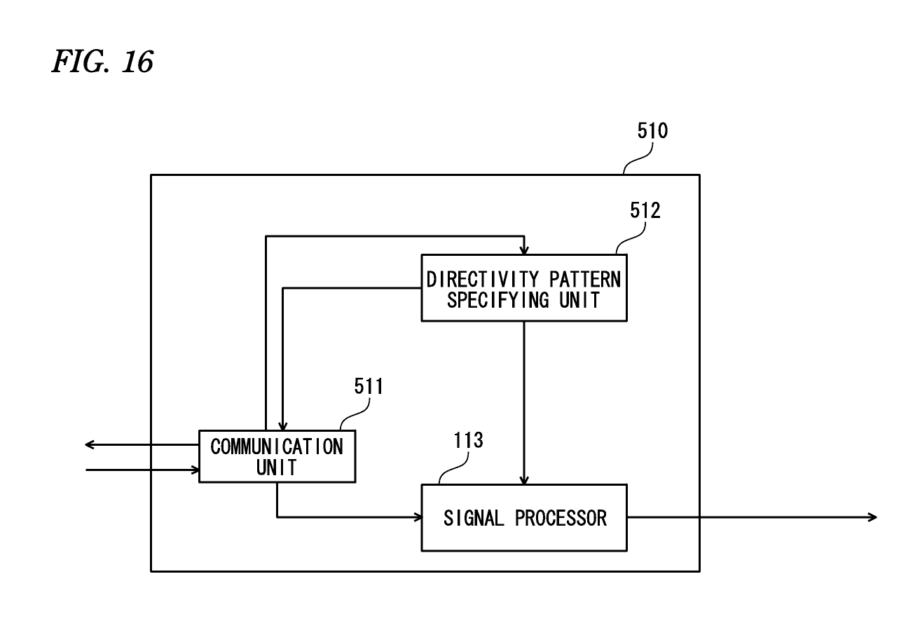

Next, a radio base station 510 according to a fifth embodiment will be described. FIG. 16 is a block diagram of the radio base station 510 according to the fifth embodiment. A communication system according to the fifth embodiment will not be described in detail because it is different from the communication system according to the first embodiment only in that the radio base station 510 replaces the radio base station 110.

The radio base station 510 is different from the radio base stations according to the first to fourth embodiments in that the radio base station 510 acquires RSSIs for plural directivity patterns by (i) sending data frames with the plural directivity patterns and (ii) receiving ACK frames for the data frames with the plural directivity patterns.

The radio base station 510 acquires RSSIs for plural directivity patterns in wireless communication exchanges according to IEEE 802.11 of data frames and ACK frames between the radio base station 510 and the wireless terminal 20 after establishment of a connection, by means of the method described in the fourth embodiment.

FIG. 16 is a block diagram of the radio base station 510 according to the fifth embodiment. In the radio base station 510, a communication unit 511 and a directivity pattern specifying unit 512 are different in function from the communication unit 111 and the directivity pattern specifying unit 112 of the radio base station 110 according to the first embodiment.

The directivity pattern specifying unit 512 indicates (specifies) to the communication unit 511 with plural directivity patterns and causes the communication unit 511 to perform communications with the thus-specified directivity patterns. In the fifth embodiment, for example, the directivity pattern specifying unit 512 instructs the communication unit 511 to switch between two different directivity patterns, that is, between a directivity pattern-1 and a directivity pattern-2.

The communication unit 511 sends a data frame and receives an ACK frame for the data frame with each directivity pattern specified by the directivity pattern specifying unit 512.

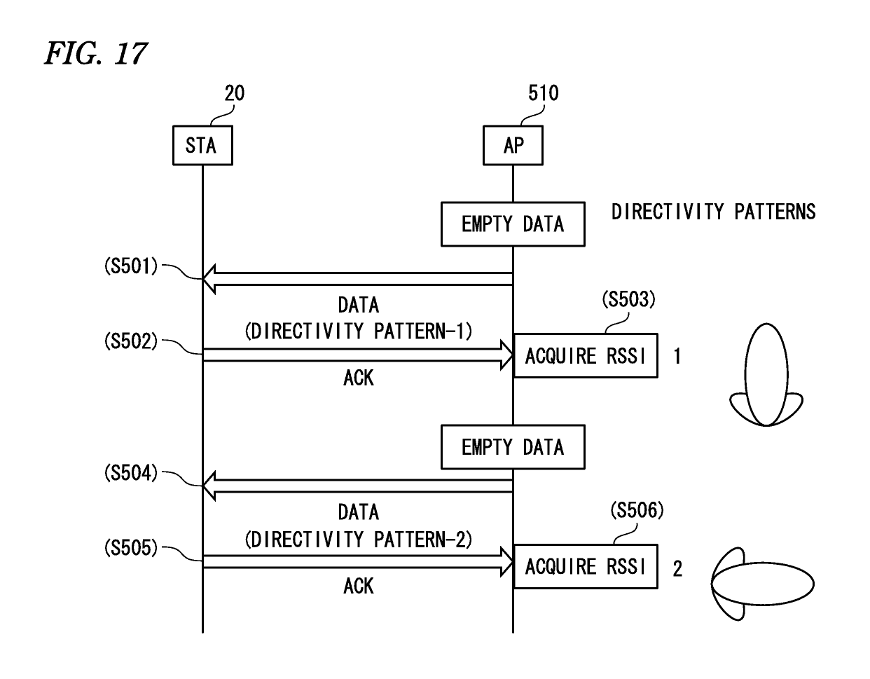

FIG. 17 is a sequence diagram showing how the radio base station 510 according to the fifth embodiment operates.

At first, after performing the back-off process according to the IEEE 802.11 standard, the communication unit 511 of the radio base station 510 sends a payloadless data frame in which (i) the MAC address of the wireless terminal 20 is set in a destination address field and (ii) the MAC address of the radio base station 510 is set in a transmission source address field, to the connection-established wireless terminal 20 with the directivity pattern-1 specified by the directivity pattern specifying unit 512 (step S501). There are no limitations on a timing at which this data frame is transmitted. The data frame may be sent either immediately after or a certain time after the establishment of the connection of the wireless terminal 20 to the radio base station 510. Alternatively, the communication unit 511 may send out a data frame having a payload portion. In this case, the payload portion may include (i) a bit sequence which is a random arrangement of “0” and “1” and (ii) the MAC address of the radio base station 510. It should be noted that the concept of the fifth embodiment is not limited thereto.

If correctly receiving the data frame directed to the wireless terminal 20, the wireless terminal 20 sends an ACK frame to the radio base station 510 as a delivery acknowledgment response after an SIFS period elapses from a time when the wireless terminal 20 receives the data frame (step S502).

The communication unit 511 of the radio base station 510 receives the ACK frame directed to the radio base station 510 with the directivity pattern-1. At step S503, the signal processor 113 calculates an RSSI of the ACK frame received with the directivity pattern-1. The signal processor 113 generates relation information-1 including (i) the MAC address of the wireless terminal 20 (ACK frame transmission source) set in the destination address field of the data frame sent, (ii) identification information to identify the directivity pattern-1, and (iii) the calculated RSSI. The signal processor 113 sends the generated relation information-1 to the outside (e.g., to a position estimating device (not shown)). Alternatively, the signal processor 113 may store the generated relation information-1 in the radio base station 510, for example, in a separately provided storage (not shown).

Subsequently, after performing the back-off process according to the IEEE 802.11 standard, the communication unit 511 of the radio base station 510 sends a payloadless data frame in which (i) the MAC address of the wireless terminal 20 is set in a destination address field and (ii) the MAC address of the radio base station 510 is set in a transmission source address field, to the wireless terminal 20 with the directivity pattern-2 specified by the directivity pattern specifying unit 512 (step S504).

If correctly receiving the data frame directed to the wireless terminal 20, the wireless terminal 20 sends an ACK frame to the radio base station 510 as a delivery acknowledgment response after an SIFS period elapses from a time when the terminal 20 receives the data frame (step S505).

The communication unit 511 of the radio base station 510 receives the ACK frame directed to the radio base station 510 with the directivity pattern-2. At step S506, the signal processor 113 calculates an RSSI of the ACK frame received with the directivity pattern-2. The signal processor 113 generates relation information-2 including (i) the MAC address of the wireless terminal 20 (ACK frame transmission source) set in the destination address field of the data frame sent, (ii) identification information to identify the directivity pattern-2, and (iii) the calculated RSSI. The signal processor 113 sends the generated relation information-2 to the outside (e.g., to the position estimating device (not shown)). Alternatively, the signal processor 113 may store the generated relation information-2 in the radio base station 510, for example, in a separately provided storage (not shown).

The acquired two relation information may be used for, for example, estimation of a position of the wireless terminal 20.

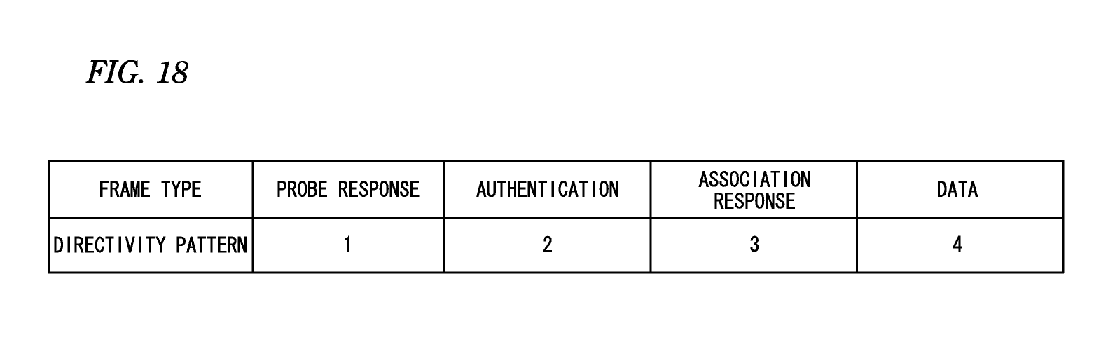

As described above, as for an exchange of a data frame and an ACK frame performed between a radio base station and a wireless terminal after establishment of a connection between the radio base station and the wireless terminal, the IEEE 802.11 standard prescribes that when receiving a data frame sent from the radio base station, the wireless terminal should return an ACK frame after an SIFS period elapses. Therefore, the radio base station 510 according to the fifth embodiment can acquire plural RSSIs for plural directivity patterns at a desired timing according to controls performed by the radio base station 510. In the fifth embodiment, the radio base station 510 may also have the functions of some of the radio base stations of the first to fourth embodiments. In this case, the radio base station 510 can acquire plural RSSIs by (i) sending all or part of a Probe Response frame, an Authentication frame, an Association Response frame, and a data frame with plural directivity patterns and (ii) receiving ACK frames for those frames with the plural directivity patterns. In this case, the directivity pattern specifying unit 512 of the radio base station 510 may specify a directivity pattern in accordance with a correspondence table shown in FIG. 18 in which frame types are associated with directivity patterns.

Like the first embodiment, the fifth embodiment is directed to the example communication system having one radio base station and one wireless terminal. It should be noted, however, that the concept of the embodiment is applicable to a communication system having plural radio base stations or plural wireless terminals.

### Sixth Embodiment

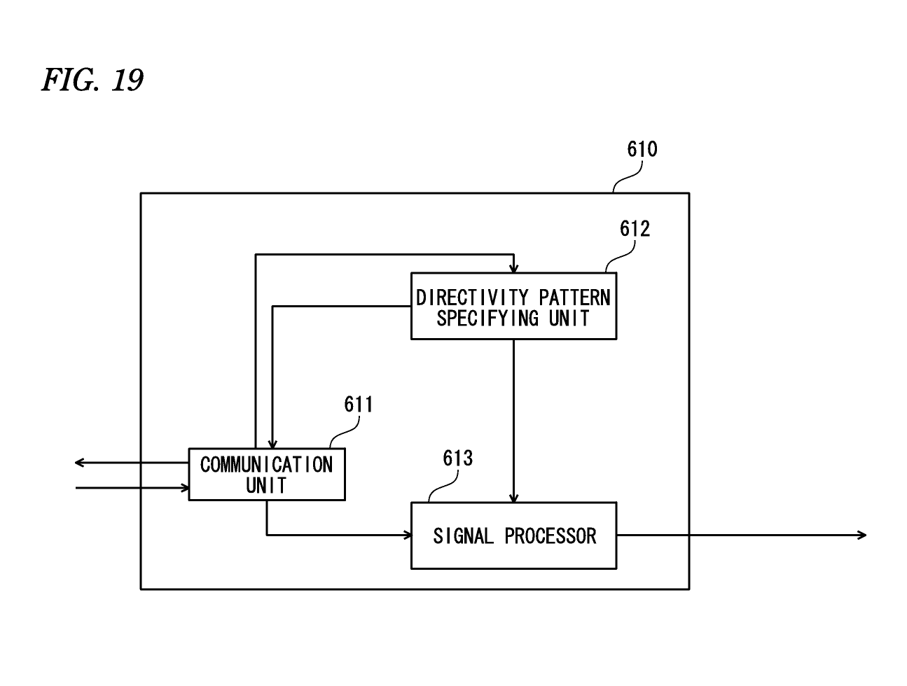

Next, a radio base station 610 according to a sixth embodiment will be described. FIG. 19 is a block diagram of the radio base station 610 according to the sixth embodiment. A communication system according to the sixth embodiment will not be described in detail because it is different from the communication system according to the first embodiment only in that the radio base station 610 replaces the radio base station 110.

Unlike the radio base station 510, the radio base station 610 calculates plural radio wave intensities by (i) sending a data frame to the wireless terminal 20 only one time and (ii) multiplying a response ACK frame by plural weight matrices. Specifically, a communication unit 611, a directivity pattern specifying unit 612, and a signal processor 613 are different in function from the communication unit 111, the directivity pattern specifying unit 112, and the signal processor 113 of the radio base station 110 according to the first embodiment, respectively.

The communication unit 611 sends a data frame to the wireless terminal 20 with a certain directivity pattern and receives an ACK frame for the data frame from the wireless terminal 20 with the certain directivity pattern. For example, the communication unit 611 may receive an ACK frame for a data frame with a non-directional directivity pattern.

The directivity pattern specifying unit 612 indicates (specifies) to the signal processor 613 with weight matrices (corresponding to respective directivity patterns) which is to be multiplied by an ACK frame.

The signal processor 613 calculates plural RSSIs by multiplying a received ACK frame by the weight matrices specified by the directivity pattern specifying unit 212.

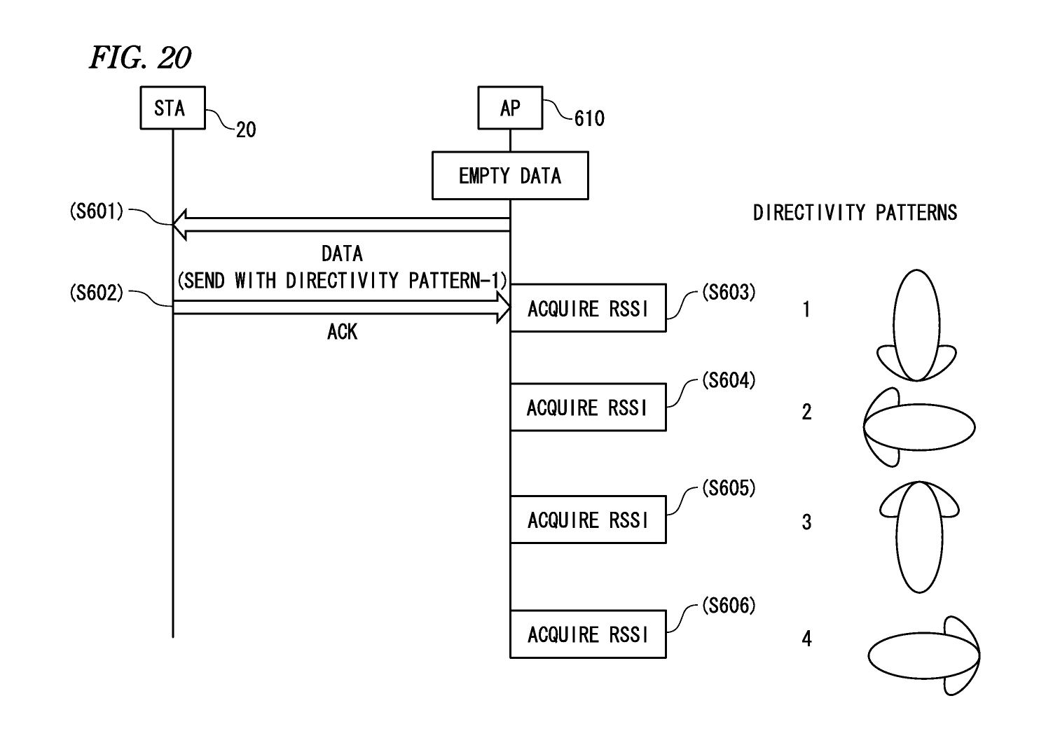

FIG. 20 is a sequence diagram showing how the radio base station 610 according to the sixth embodiment operates.

First, after performing the back-off process according to the IEEE 802.11 standard, the communication unit 611 of the radio base station 610 sends, to the connection-established wireless terminal 20, a payloadless data frame in which (i) the MAC address of the wireless terminal 20 is set in a destination address field and (ii) the MAC address of the radio base station 610 is set in a transmission source address field (step S601). There are no limitations on a timing at which the data frame is transmitted and a transmission trigger. The data frame may be sent either immediately after or a certain time after the establishment of the connection of the wireless terminal 20 to the radio base station 610. Alternatively, the communication unit 611 may send out a data frame having a payload portion. In this case, the payload portion may include (i) a bit sequence which is a random arrangement of “0” and “1” and (ii) the MAC address of the radio base station 610. The concept of the sixth embodiment is not limited thereto.

If correctly receiving the data frame directed to the wireless terminal 20, the wireless terminal 20 sends an ACK frame to the radio base station 610 as a delivery acknowledgment response after an SIFS period elapses from the wireless terminal 20 receives the data frame (step S602).

The radio base station 610 receives the ACK frame directed to the radio base station 610 and stores the ACK frame in the signal processor 613.

At step S603, the signal processor 613 calculates an RSSI by multiplying the ACK frame signal stored therein by a weight matrix corresponding to a directivity pattern-1 according to an instruction from the directivity pattern specifying unit 612. Then, the signal processor 613 sends, to the outside (e.g., to a position estimating device (not shown)), relation information-1 including (i) the MAC address of the wireless terminal 20 (ACK frame transmission source) set in the destination address field of the data frame sent from the communication unit 611, (ii) identification information to identify the directivity pattern-1, and (iii) the calculated RSSI of the ACK frame. Alternatively, the signal processor 613 may store the generated relation information-1 in the radio base station 610, for example, in a separately provided storage (not shown).

Subsequently, at step S604, the signal processor 613 calculates an RSSI by multiplying the ACK frame signal stored therein by a weight matrix corresponding to a directivity pattern-2 according to an instruction from the directivity pattern specifying unit 612. Then, the signal processor 613 sends, to the outside (e.g., to the position estimating device (not shown)), relation information-2 including (i) the MAC address of the wireless terminal 20 (ACK frame transmission source) set in the destination address field of the data frame sent from the communication unit 611, (ii) identification information to identify the directivity pattern-2, and (iii) the calculated RSSI of the ACK frame. Alternatively, the signal processor 613 may store the generated relation information-2 in the radio base station 610, for example, in a separately provided storage (not shown).

Subsequently, at step S605, the signal processor 613 calculates an RSSI by multiplying the ACK frame signal stored therein by a weight matrix corresponding to a directivity pattern-3 according to an instruction from the directivity pattern specifying unit 612. Then, the signal processor 613 sends, to the outside (e.g., to the position estimating device (not shown)), relation information-3 including (i) the MAC address of the wireless terminal 20 (ACK frame transmission source) set in the destination address field of the data frame sent from the communication unit 611, (ii) identification information to identify the directivity pattern-3, and (iii) the calculated RSSI of the ACK frame. Alternatively, the signal processor 613 may store the generated relation information-3 in the radio base station 610, for example, in a separately provided storage (not shown).

Subsequently, at step S606, the signal processor 613 calculates an RSSI by multiplying the ACK frame signal stored therein by a weight matrix corresponding to a directivity pattern-4 according to an instruction from the directivity pattern specifying unit 612. Then, the signal processor 613 sends, to the outside (e.g., to the position estimating device (not shown)), relation information-4 including (i) the MAC address of the wireless terminal 20 (ACK frame transmission source) set in the destination address field of the data frame sent from the communication unit 611, (ii) identification information to identify the directivity pattern-4, and (iii) the calculated RSSI of the ACK frame. Alternatively, the signal processor 613 may store the generated relation information-4 in the radio base station 610, for example, in a separately provided storage (not shown).

The acquired four relation information can be used for, for example, estimation of a position of the wireless terminal 20.

According to the sixth embodiment, the signal processor 613 multiplies an ACK frame for a single data frame by weight matrices corresponding to plural respective directivity patterns (this process is within the IEEE 802.11 standard). Therefore, the radio base station 610 can acquire plural RSSIs at a desired timing according to controls performed by the radio base station 610 without a new function being added to the wireless terminal 20.

Like the first embodiment, the sixth embodiment is directed to the example communication system having one radio base station and one wireless terminal. It should be noted, however, that the concept of the sixth embodiment is applicable to a communication system having plural radio base stations or plural wireless terminals.

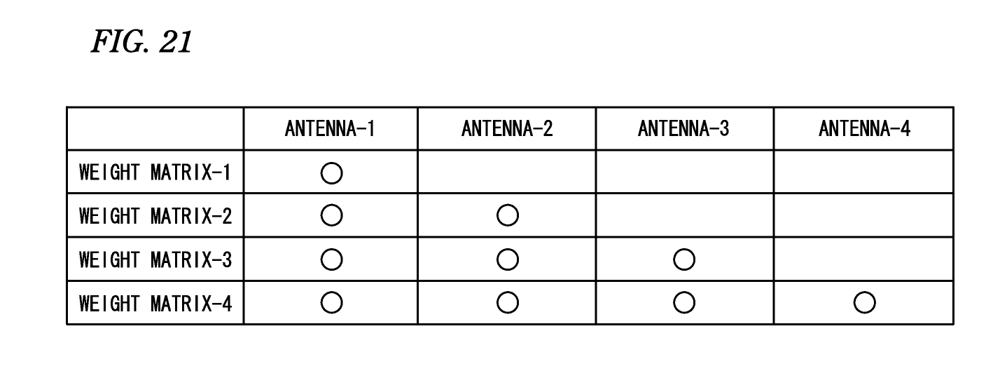

In the first to sixth embodiments, RSSIs are calculated by antenna switching, beam forming or using one of weight matrices corresponding to directivity patterns. Alternatively, a combination of two of these methods (e.g., antenna pattern switching and weight matrix) may be used. In this case, it is possible to create a table indicating combinations of a directional antenna and a weight matrix in advance as shown in FIG. 21 by, for example, a design-of-experiments technique and to acquire RSSIs using combinations that are marked “o” in the table.

In the first to sixth embodiments, the signal processor of the radio base station acquires RSSIs using plural directivity patterns. Alternatively, the signal processor may acquire, in additions to an RSSI, an SNR (signal-to-noise ratio), a delay profile, and/or channel information. Such additional information acquired may be stored or sent to the outside together with the relation information described above.

At least one of the above-described embodiments makes it possible for a single radio base station to acquire RSSIs for plural directivity patterns from radio signals transmitted from a single wireless terminal, within the IEEE 802.11 standard without a new function being added to the wireless terminal even if the sole radio base station is provided in a communication system.

For example, the radio base station according to each of the first to sixth embodiments may be implemented using a general-purpose computer as a base hardware. That is, the communication unit, the directivity pattern specifying unit, and the signal processor used in each of the first to sixth embodiments may be implemented by causing a processor of the computer to run programs. In this case, the radio base station according to each of the first to sixth embodiments may be implemented by either pre-installing the programs in the computer or installing the programs in the computer when necessary by delivering the programs over a network or in such a manner that the programs are stored in a storage medium such as a CD-ROM. The storage unit used in each of the fourth embodiment and the modifications of the first and fourth embodiments may be implemented using, as appropriate, a memory or a hard disk drive built in or connected externally to the computer or another storage medium such as a CD-R, CD-RW, DVD-RAM, or DVD-R.

The several embodiments have been described above. It should be noted, however, that the described embodiments are just examples and are not intended to limit the scope of the invention. Each of the embodiments may be practiced in various other forms, and part of it may be omitted, replaced by other elements, or changed in various manners without departing from the spirit and scope of the invention. These modifications are also included in the invention as claimed and its equivalents.

What is claimed is:

1. A radio base station that performs wireless communication with a wireless terminal, the radio base station comprising:
a directivity pattern specifying unit that specifies plural directivity patterns;
a communication unit that
receives a search request frame from the wireless terminal,
sends to the wireless terminal a search response frame which is a response to the search request frame, with at least one, specified by the directivity pattern specifying unit, of the directivity patterns, and
receives a delivery acknowledgment frame for the search response frame from the wireless terminal with the directivity patterns specified by the directivity pattern specifying unit; and
a signal processor that calculates, for each specified directivity pattern, a radio wave intensity of the delivery acknowledgment frame.

2. The radio base station of claim 1, wherein
the radio base station and the wireless terminal perform wireless communication according to IEEE 802.11,
the search request frame is a Probe Request frame including a MAC address of the wireless terminal in a transmission source address field thereof,
the search response frame is a Probe Response frame including the MAC address of the wireless terminal in a destination address field thereof, and
the delivery acknowledgment frame is an ACK frame.

3. The radio base station of claim 1, wherein the signal processor generates, for each directivity pattern, relation information including (i) identification information to identify each directivity pattern, (ii) the radio wave intensity calculated based on the delivery acknowledgment frame, and (iii) the MAC address of the wireless terminal.

4. A radio base station that performs wireless communication with a wireless terminal, the radio base station comprising:
a communication unit that
receives a search request frame from the wireless terminal,
sends to the wireless terminal a search response frame which is a response to the search request frame, and
receives a delivery acknowledgment frame for the search response frame from the wireless terminal;
a directivity pattern specifying unit that specifies plural directivity patterns; and
a signal processor that calculates radio wave intensities by multiplying the delivery acknowledgment frame by weight matrices which correspond to the directivity patterns specified by the directivity pattern specifying unit, respectively.

5. The radio base station of claim 4, wherein
the radio base station and the wireless terminal perform wireless communication according to IEEE 802.11,
the search request frame is a Probe Request frame,
the search response frame is a Probe Response frame, and
the delivery acknowledgment frame is an ACK frame.

6. The radio base station of claim 1, further comprising:
a storage unit that stores information indicating a correspondence relationship between (i) sets of directivity patterns and (ii) MAC addresses for identification of wireless terminals, wherein
the directivity pattern specifying unit specifies the plural directivity patterns to the communication unit in accordance with a set of directivity patterns that is stored in the storage unit in association with a MAC address included in a transmission source field of the search request frame received by the communication unit.

7. The radio base station of claim 1, wherein the search response frame which the communication unit sends with the respective directivity patterns specified by the directivity pattern specifying unit is search response frames in which different MAC addresses of the radio base station are set.

8. The radio base station of claim 1, wherein
the communication unit
sends an authentication frame to the wireless terminal with another one, specified by the directivity pattern specifying unit, of the directivity patterns, and
receives a second delivery acknowledgment frame for the authentication frame from the wireless terminal with said another one, specified by the directivity pattern specifying unit, of the directivity patterns, and
the signal processor calculates a radio wave intensity of the second delivery acknowledgment frame.

9. The radio base station of claim 8, wherein the authentication frame is an Authentication frame in which a destination address field includes a MAC address of the wireless terminal.

10. The radio base station of claim 8, wherein
the communication unit
receives a connection request frame from the wireless terminal,
sends to the wireless terminal a connection response frame which is a response to the connection request frame, with further another one, specified by the directivity pattern specifying unit, of the directivity patterns, and
receives a third delivery acknowledgment frame for the connection response frame from the wireless terminal with said further another one, specified by the directivity pattern specifying unit, of the directivity patterns, and
the signal processor calculates a radio wave intensity of the third delivery acknowledgment frame.

11. The radio base station of claim 10, wherein
the connection request frame is an Association Request frame including a MAC address of the wireless terminal in a transmission source filed thereof, and
the connection response frame is an Association Response frame including the MAC address of the wireless terminal in a destination address filed.

12. The radio base station of claim 11, wherein
the search response frame is a Probe Response frame,
the radio base station further comprising:
a storage unit that stores information indicating a corresponding relationship between (i) the directivity patterns and (ii) frames types including the Probe Response frame, the Authentication frame, and the Association Response frame, wherein
the directivity pattern specifying unit specifies to the communication unit the directivity patterns according to the information indicating the corresponding relationship stored in the storage unit.

13. The radio base station of claim 11, wherein the second delivery acknowledgment frame and the third delivery acknowledgment frame are ACK frames.

14. The radio base station of claim 1, wherein
the communication unit
sends data frames to the wireless terminal with the directivity patterns specified by the directivity pattern specifying unit, and
receives second delivery acknowledgment frames for the respective data frames from the wireless terminal with the directivity patterns specified by the directivity pattern specifying unit, and
the signal processor calculates radio wave intensities of the second delivery acknowledgment frames for the respective directivity patterns.

15. The radio base station of claim 1, wherein
the communication unit sends a data frame to the wireless terminal and receives a second delivery acknowledgment frame for the data frame from the wireless terminal, and
the signal processor calculates radio wave intensities by multiplying the second delivery acknowledgment frame by weight matrices corresponding to the plural directivity patterns specified by the directivity pattern specifying unit, respectively.

16. The radio base station of claim 14, wherein the second delivery acknowledgment frame is an ACK frame.

17. The radio base station of claim 15, wherein the second delivery acknowledgment frame is an ACK frame.

18. The radio base station of claim 1, wherein the signal processor calculates RSSIs as the radio wave intensities.

19. The radio base station of claim 18, wherein the signal processor acquires at least one of an SNR, a delay profile, and channel information.

20. A non-transitory computer readable storage medium storing a program controlling a radio base station that performs wireless communication with a wireless terminal, the program causing the radio base station to execute a wireless communication process comprising:
specifying plural directivity patterns;
receiving a search request frame from the wireless terminal;
sending to the wireless terminal a search response frame which is a response to the search request frame with at least one of the specified directivity patterns;
receiving a delivery acknowledgment frame for the search response frame from the wireless terminal with the specified directivity patterns; and
calculating, for each specified directivity pattern, a radio wave intensity of the delivery acknowledgment frame.
